(19) United States
(12) Patent Application Publication
(10) Pub. No.: US 2007/0212604 A1
(43) Pub. Date: Sep. 13, 2007

(54) Bipolar battery

(76) Inventors: Stanford R. Ovshinsky, Bloomfield Hills, MI (US); John Smaga, Franklin, MI (US); Lin R. Higley, Troy, MI (US); Ronald Himmler, Sterling Heights, MI (US); Jason Luesing, Hazel Park, MI (US); Theodore Olszanski, Rochester Hills, MI (US)

Correspondence Address: Philip H. Schlazer;Energy Conversion Devices, Inc, 2956 Waterview Drive, Rochester Hills, MI, 48309, US

(21) Appl. No.: 11/373,446

(22) Filed: Mar. 11, 2006

(51) Int. Cl. H01M 4/02; H01M 4/58; H01M 4/52

(52) U.S. Cl. 429/210; 429/218.2; 429/223

(57) ABSTRACT

A bipolar battery comprising bipolar electrodes. The bipolar electrodes including corrugated bipolar substrates. The corrugated bipolar substrates may be formed as corrugated foils. The battery may be a nickel metal hydride battery.

### FIELD OF THE INVENTION

The present invention relates to batteries. In particular, the present invention relates to bipolar batteries.

### BACKGROUND OF THE INVENTION

In rechargeable electrochemical battery cells, weight and portability are important considerations. It is also advantageous for rechargeable battery cells to have long operating lives without the necessity of periodic maintenance. Rechargeable electrochemical battery cells are used in numerous consumer devices such as calculators, portable radios, laptop computers, cordless power tools and cellular phones. They are often configured into a sealed power pack that is designed as an integral part of a specific device. Rechargeable electrochemical cells can also be configured as larger batteries. Likewise, batteries may be configured are battery packs or battery modules.

Rechargeable electrochemical battery cells may be classified as “nonaqueous” cells or “aqueous” cells. An example of a nonaqueous electrochemical battery cell is a lithium-ion cell, which uses intercalation compounds for both anode and cathode, and a liquid organic or polymer electrolyte. Aqueous electrochemical cells may be classified as either “acidic” or “alkaline”. An example of an acidic electrochemical battery cell is a lead-acid cell, which uses lead dioxide as the active material of the positive electrode and metallic lead, in a high-surface area porous structure, as the negative active material. Many of the alkaline electrochemical battery cells are nickel based. Examples of such cells are nickel cadmium cells (NiCd), nickel metal hydride cells (NiMH), nickel hydrogen cells (NiH), nickel zinc cells (NiZn), and nickel iron cells (NiFe).

NiMH cells use negative electrodes having a hydrogen absorbing alloy as the active material. The hydrogen absorbing alloy is capable of the reversible electrochemical storage of hydrogen. NiMH cells typically use a positive electrode having nickel hydroxide as the active material. The negative and positive electrodes are spaced apart in an alkaline electrolyte such as potassium hydroxide.

Upon application of an electrical current across a NiMH cell, water is dissociated into a hydroxyl ion and a hydrogen ion at the surface of the negative electrode. The hydrogen ion combines with one electron and forms atomic hydrogen and diffuses into the bulk of the hydrogen storage alloy. This reaction is reversible. Upon discharge, the stored hydrogen is released to form a hydrogen ion and an electron. The hydrogen ion combines with a hydroxyl ion to form water. This is shown in equation (1):

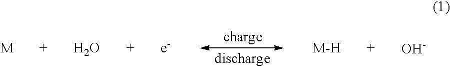

The reactions that take place at the nickel hydroxide positive electrode of a Ni—MH battery cell are shown in equation (2):

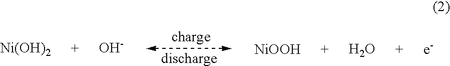

The use of disordered negative electrode metal hydride material significantly increases the reversible hydrogen storage characteristics required for efficient and economical electrochemical cell applications, and results in the commercial production of electrochemical cells having high energy density storage, efficient reversibility, high electrical efficiency, bulk hydrogen storage without structural change or poisoning, long cycle life, and deep discharge capability.

Certain hydrogen absorbing alloys result from tailoring the local chemical order and local structural order by the incorporation of selected modifier elements into a host matrix. Disordered hydrogen absorbing alloys have a substantially increased density of catalytically active sites and storage sites compared to single or multi-phase crystalline materials. These additional sites are responsible for improved efficiency of electrochemical charging/discharging and an increase in electrical energy storage capacity. The nature and number of storage sites can even be designed independently of the catalytically active sites. More specifically, these alloys are tailored to allow bulk storage of the dissociated hydrogen atoms at bonding strengths within the range of reversibility suitable for use in secondary battery applications.

The use of disordered negative electrode metal hydride material significantly increases the reversible hydrogen storage characteristics required for efficient and economical battery applications, and results in the commercial production of batteries having high energy density storage, efficient reversibility, high electrical efficiency, bulk hydrogen storage without structural change or poisoning, long cycle life, and deep discharge capability.

Some extremely efficient electrochemical hydrogen storage alloys were formulated, based on the disordered materials described above. These are the Ti—V—Zr—Ni type active materials such as disclosed in U.S. Pat. No. 4,551,400 (“the '400 Patent”) the disclosure of which is incorporated herein by reference. These materials reversibly form hydrides in order to store hydrogen. All the materials used in the '400 Patent utilize a generic Ti—V—Ni composition, where at least Ti, V, and Ni are present and may be modified with Cr, Zr, and Al. The materials of the '400 Patent are multiphase materials, which may contain, but are not limited to, one or more phases with C₁₄ and C₁₅ type crystal structures.

Other Ti—V—Zr—Ni alloys, also used for rechargeable hydrogen storage negative electrodes, are described in U.S. Pat. No. 4,728,586 (“the '586 Patent”), the contents of which is incorporated herein by reference. The '586 Patent describes a specific sub-class of Ti—V—Ni—Zr alloys comprising Ti, V, Zr, Ni, and a fifth component, Cr. The '586 Patent, mentions the possibility of additives and modifiers beyond the Ti, V, Zr, Ni, and Cr components of the alloys, and generally discusses specific additives and modifiers, the amounts and interactions of these modifiers, and the particular benefits that could be expected from them. Other hydrogen absorbing alloy materials are discussed in U.S. Pat. Nos. 5,096,667, 5,135,589, 5,277,999, 5,238,756, 5,407,761, and 5,536,591, the contents of which are incorporated herein by reference.

The positive electrodes of a Ni-MH battery cell include a nickel hydroxide material as the active electrode material. Generally, any nickel hydroxide material may be used. The nickel hydroxide material used may be a disordered material. The use of disordered materials allow for permanent alteration of the properties of the material by engineering the local and intermediate range order. The general principles are discussed in U.S. Pat. No. 5,348,822, the contents of which are incorporated by reference herein. The nickel hydroxide material may be compositionally disordered. “Compositionally disordered” as used herein is specifically defined to mean that this material contains at least one compositional modifier and/or a chemical modifier. Also, the nickel hydroxide material may also be structurally disordered. “Structurally disordered” as used herein is specifically defined to mean that the material has a conductive surface and filamentous regions of higher conductivity, and further, that the material has multiple or mixed phases where alpha, beta, and gamma-phase regions may exist individually or in combination.

The nickel hydroxide material may comprise a compositionally and structurally disordered multiphase nickel hydroxide host matrix which includes at least one modifier chosen from the group consisting of Al, Ba, Bi, Ca, Co, Cr, Cu, F, Fe, In, K, La, Li, Mg, Mn, Na, Nd, Pb, Pr, Ru, Sb, Sc, Se, Sn, Sr, Te, Ti, Y, and Zn. The nickel hydroxide material may include a compositionally and structurally disordered multiphase nickel hydroxide host matrix which includes at least three modifiers chosen from the group consisting of Al, Ba, Bi, Ca, Co, Cr, Cu, F, Fe, In, K, La, Li, Mg, Mn, Na, Nd, Pb, Pr, Ru, Sb, Sc, Se, Sn, Sr, Te, Ti, Y, and Zn. These embodiments are discussed in detail in commonly assigned U.S. Pat. No. 5,637,423 the contents of which is incorporated by reference herein.

The nickel hydroxide materials may be multiphase polycrystalline materials having at least one gamma-phase that contain compositional modifiers or combinations of compositional and chemical modifiers that promote the multiphase structure and the presence of gamma-phase materials. These compositional modifiers are chosen from the group consisting of Al, Bi, Co, Cr, Cu, Fe, In, LaH₃, Mg, Mn, Ru, Sb, Sn, TiH₂, TiO, Zn. Preferably, at least three compositional modifiers are used. The nickel hydroxide materials may include the non-substitutional incorporation of at least one chemical modifier around the plates of the material. The phrase “non-substitutional incorporation around the plates”, as used herein means the incorporation into interlamellar sites or at edges of plates. These chemical modifiers are preferably chosen from the group consisting of Al, Ba, Ca, Co, Cr, Cu, F, Fe, K, Li, Mg, Mn, Na, Sr, and Zn.

The nickel hydroxide material may comprise a solid solution nickel hydroxide material having a multiphase structure that comprises at least one polycrystalline gamma-phase including a polycrystalline gamma-phase unit cell comprising spacedly disposed plates with at least one chemical modifier incorporated around the plates. The plates may have a range of stable intersheet distances corresponding to a 2⁺ oxidation state and a 3.5⁺, or greater, oxidation state. The nickel hydroxide material may include at least three compositional modifiers incorporated into the solid solution nickel hydroxide material to promote the multiphase structure. This embodiment is fully described in U.S. Pat. No. 5,348,822, the contents of which is incorporated by reference herein.

Preferably, one of the chemical modifiers is chosen from the group consisting of Al, Ba, Ca, Co, Cr, Cu, F, Fe, K, Li, Mg, Mn, Na, Sr, and Zn. The compositional modifiers may be chosen from the group consisting of a metal, a metallic oxide, a metallic oxide alloy, a metal hydride, and a metal hydride alloy. Preferably, the compositional modifiers are chosen from the group consisting of Al, Bi, Co, Cr, Cu, Fe, In, LaH₃, Mn, Ru, Sb, Sn, TiH₂, TiO, and Zn. In one embodiment, one of the compositional modifiers is chosen from the group consisting of Al, Bi, Co, Cr, Cu, Fe, In, LaH₃, Mn, Ru, Sb, Sn, TiH₂, TiO, and Zn. In another embodiment, one of the compositional modifiers is Co. In an alternate embodiment, two of the compositional modifiers are Co and Zn. The nickel hydroxide material may contain 5 to 30 atomic percent, and preferable 10 to 20 atomic percent, of the compositional or chemical modifiers described above.

The disordered nickel hydroxide electrode materials may include at least one structure selected from the group consisting of (i) amorphous; (ii) microcrystalline; (iii) polycrystalline lacking long range compositional order; and (iv) any combination of these amorphous, microcrystalline, or polycrystalline structures.

Also, the nickel hydroxide material may be a structurally disordered material comprising multiple or mixed phases where alpha, beta, and gamma-phase region may exist individually or in combination and where the nickel hydroxide has a conductive surface and filamentous regions of higher conductivity.

Nickel-metal hydride batteries are used in many different applications. For example, nickel-metal hydride batteries are used in numerous consumer devices such as calculators, portable radios, cellular phones, power tools and uninterruptable power supplies. They are also used in many different vehicle applications. For example, nickel-metal hydride batteries are used to drive fork lifts, golf carts, pure electric vehicles (EV) as well as hybrid electric vehicles (HEV). Hybrid electric vehicles utilize the combination of a combustion engine and an electric motor driven from a battery.

Extensive research has been conducted in the past into improving the electrochemical aspects of the power and charge capacity of nickel-metal hydride batteries. This is discussed in detail, for example, in U.S. Pat. Nos. 5,096,667, 5,104,617, 5,238,756, 5,277,999, and 5,536,591 the contents of which are all incorporated by reference herein.

Multi-cell nickel-metal hydride batteries may be packaged in a variety of configurations. For example, individual cells may simply be secured together with the use of end plates and a strap to form a “bundle” of individual cells. Alternatively, the individual cells may be all be housed within a common outer battery case.

The electrochemical cells of multi-cell batteries may be electrically coupled in series by conductive links, or they may be formed in a bipolar configuration where an electrically conductive bipolar plate may serve as the electrical interconnection between adjacent cells as well as a partition between the cells. Examples of bipolar batteries are provided in U.S. Pat. Nos. 5,393,617, 5,478,363, 5,552,243, 5,618,641 and 6,969,567, the disclosures of which are all incorporated by reference herein.

The requirements for making high quality multi-cell rechargeable batteries may become more difficult to achieve in the case of nickel-metal hydride batteries due to the charging potential of the cells which can accelerate corrosion of battery components, to the creep nature of the alkaline electrolyte that can cause self-discharge between cells, and to the higher cell pressures which can deform and damage the cell enclosures. The present invention provides an improved design for rechargeable multi-cell batteries applicable to all battery chemistries and, in particular, to the rechargeable nickel-metal hydride chemistry.

### SUMMARY OF THE INVENTION

An embodiment of the invention is a first bipolar battery, comprising: one or more first bipolar electrodes, each of the first bipolar electrodes including a first bipolar substrate supporting a positive active composition and a negative active composition; and an electrolyte, the first bipolar battery having a footprint smaller than the footprint of a second bipolar battery using planar bipolar plate, the capacity and chemistry of the second battery being the same as the capacity and chemistry of the first battery.

Another embodiment of the invention is a bipolar battery, comprising: a bipolar electrode comprising a bipolar substrate, the bipolar substrate having a first surface supporting a positive active composition and a second surface supporting a negative active composition, the first surface and the second surface being non-planar.

Another embodiment of the invention is a bipolar battery, comprising: a bipolar electrode, comprising: a bipolar substrate having corrugations, the corrugations forming first channels and second channels opposite the first channels; a first active composition disposed in the first channels; and second active composition disposed in the second channels, the first and second active compositions being of opposite types.

Another embodiment of the invention is a bipolar battery, comprising: a first electrode including a first substrate with first corrugations, the first corrugation forming first channels and second channels opposite the first channels; and a second electrode adjacent the first electrode, the second electrode including a second substrate with second corrugations, the second corrugations having first channels and second channels.

### BRIEF DESCRIPTION OF THE DRAWINGS

FIG. 1 is an example of a prismatic battery;

FIG. 2 is an example of a bipolar battery with flat substrates;

FIG. 3 is an embodiment of a bipolar battery of the present invention with corrugated substrates;

FIG. 4 is a side view of a cross section of the battery from FIG. 3;

FIG. 5 is a blow up view of a portion of the battery from FIG. 3;

FIG. 6A is a side view of an embodiment of a corrugated substrate;

FIG. 6B is an isometric view of an embodiment of a corrugated substrate;

FIG. 6C is an isometric view of an embodiment of a corrugated substrate;

FIG. 6D is a side view of an embodiment of a corrugated substrate;

FIG. 6E is a side view of an embodiment of a corrugated substrate;

FIG. 7 is a side view of an embodiment of a corrugated substrate;

FIG. 8 is a side view of an embodiment of a corrugated substrate;

FIG. 9 is a side view of an embodiment of a corrugated substrate;

FIG. 10 is a side view of an embodiment of a corrugated substrate;

FIG. 11 is a side view of an embodiment of a corrugated substrate;

FIG. 12 is an isometric view of an embodiment of a corrugated substrate;

FIG. 13 is an isometric view of an embodiment of a corrugated substrate;

FIG. 14 shows a view of nested substrates; and

FIG. 15 shows an isometric view of an embodiment of a corrugated substrate.

### DETAILED DESCRIPTION OF THE INVENTION

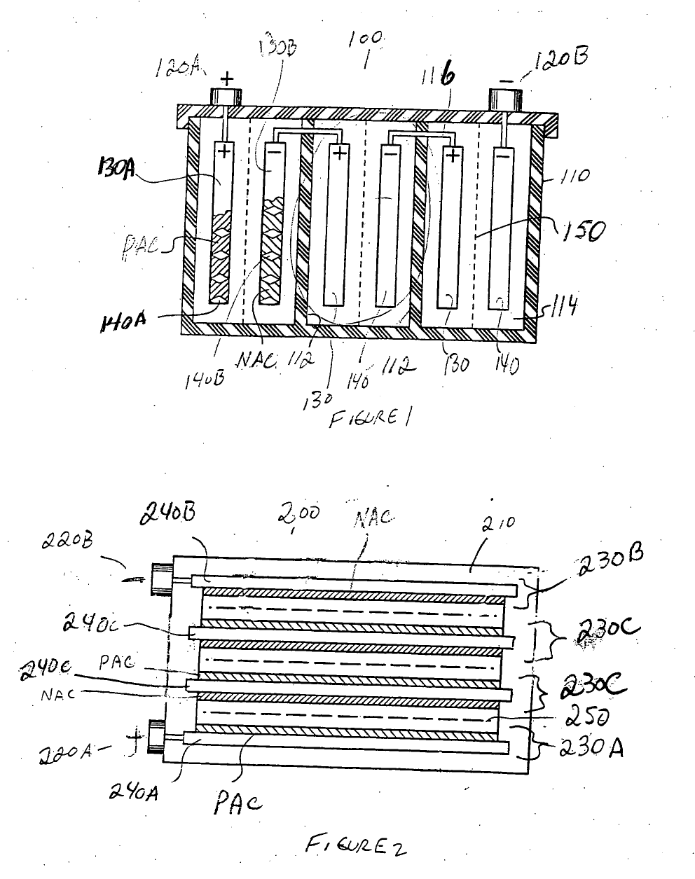

An example of a conventional prismatic battery is shown as battery 100 in FIG. 1. Battery 100 includes a battery case 110 that has a positive terminal 120A and a negative terminal 120 B. The battery 100 is divided by partitions 112 into a plurality of cell compartments 114. Each cell compartment 114 houses an individual electrochemical cell (also referred to as a battery cell) comprising at least one positive electrode 130A and at least one negative electrode 130B. The positive and negative electrodes are contacted by an electrolyte disposed within each of the cells. The positive electrode 130A includes a positive active composition PAC affixed to a positive electrode substrate 140A. The negative electrode 130B includes a negative active composition NAC affixed to a negative electrode substrate 140B. The positive active composition PAC includes a positive active material PAM (such as, for example, a nickel hydroxide material) and may include additional materials. Likewise, the negative active composition NAC includes a negative active material NAM (such as, for example, a hydrogen storage alloy) and may include additional materials.

It is noted that the positive electrode and negative electrode are considered electrodes of “opposite” types. Likewise, a positive active composition and a negative active composition are considered active compositions of “opposite” types. Likewise, a positive active material and a negative active material are considered active materials of “opposite” types. The positive electrode 130A and the negative electrode 130B are each referred to as monopolar electrodes since each includes only a positive active composition or a negative active composition. For each cell, a positive electrode 130A is separated from a negative electrode 130B by a separator 150. The separator permits ionic communication between the positive and negative electrodes of the same cell but prevents the positive electrode of each cell from physically contacting the negative electrode of the same cell. As noted, each electrochemical cell is physically separated from another electrochemical cell by a partition 112. Each electrochemical cell includes an electrolyte and each partition 116 prevents the electrolyte from one cell from entering another cell (however, it is possible that the gases of one cell intermix with the gases of one or more of the other cells). In the embodiment shown in FIG. 1, electrochemical cells are coupled in series such that the positive electrode 130A of one cell is electrically connected to the negative electrode 130B of another cell via a connector 116 that passes through the partition wall 112. The connectors 116 are sealed about their periphery to prevent electrolyte from one cell entering an adjacent cell compartment.

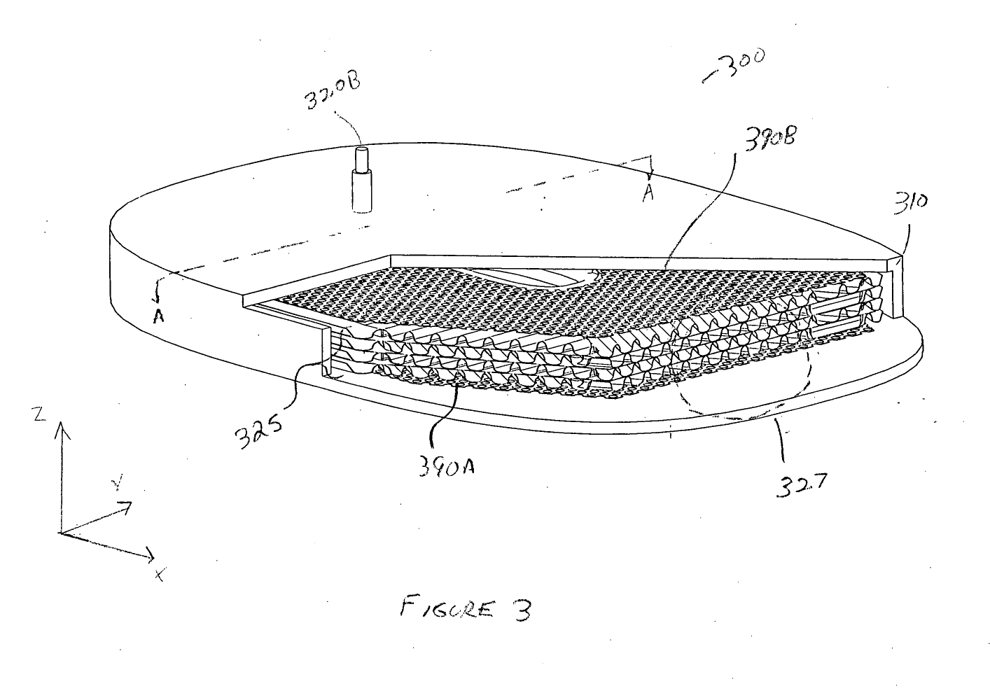

FIG. 2 provides an example of a bipolar battery 200. The bipolar battery 200 includes a battery case 210 that has a positive terminal 220A and a negative terminal 220B. The bipolar battery, as depicted in FIG. 2, includes a monopolar positive electrode 230A electrically coupled to the positive terminal 220A and a monopolar negative electrode 230B electrically coupled to the negative terminal 220B. The monopolar positive electrode 230A includes a positive electrode substrate 240A and a positive active composition PAC affixed to the positive electrode substrate 240A. The monopolar negative electrode includes a negative electrode substrate 240B and a negative active composition NAC affixed to the negative electrode substrate 240B. The bipolar battery 200 further includes bipolar electrodes 230C disposed between the positive and negative monopolar electrodes. Each bipolar electrode 230C includes a planar (e.g. flat) bipolar plate 240C, a positive active composition PAC affixed to one side of the bipolar substrate 240C, and a negative active composition NAC is affixed to the opposite side of the bipolar substrate 240C. The example shown in FIG. 2 includes two bipolar electrodes, however, there may be more than two bipolar electrodes. More generally, a bipolar battery may include one or more bipolar electrodes. As noted, in the example shown in FIG. 2, the bipolar electrode 230C as well as the bipolar plates 240C are essentially flat.

In the example shown in FIG. 2, the positive active composition of one of the electrodes faces the negative active composition of an adjacent electrode. A separator 250 is disposed between the positive active composition PAC of the one electrode and the negative active composition NAC of an adjacent electrode. The separator 250 may, for example, be a glass mat material in which electrolyte is absorbed. It is noted that the separator prevents the negative active composition of one of the bipolar electrodes from physically touching the positive active composition of an adjacent bipolar electrode (or the positive active composition of the monopolar electrode). However, the separator still permits ionic communication between the positive and negative active compositions of the same electrochemical cell. The bipolar battery 200 further includes an electrolyte.

The bipolar plate 230C also serves to partition the battery into individual electrochemical cells. The bipolar plate 230C is electrically conductive so as to create an electrical pathway between the positive active composition PAC and the negative active composition NAC of adjacent electrochemical cells. Each electrochemical cell is electrically coupled to an adjacent cell by way of the bipolar plate. Electrical current flows from the positive active composition of one cell to negative active composition of an adjacent cell through the bipolar substrate. The current flow is in a direction which is substantially perpendicular to the plane of the actual surface of the substrate. This provides a very short distance and a very large cross-sectional area through which the current passes from one cell to the next compared to the conventional prismatic battery 100 shown in FIG. 1. The bipolar plate 240C is preferably adapted to prevent positive or negative ions on one side of the substrate (in one electrochemical cell) from penetrating through the bipolar substrate to the other side (in another electrochemical cell). The bipolar plate 240C is preferably impermeable and/or impervious to the battery electrolyte so that electrolyte from one cell cannot pass though the bipolar plate and enter another electrochemical cell. The bipolar plate 240C may provide a support structure for the negative and positive active compositions.

FIG. 3 shows a cut-away view of a bipolar battery 300 which is an embodiment of a bipolar battery of the present invention. The bipolar battery 300 includes a battery case 310 that has a positive terminal (not shown in FIG. 3 but positioned opposite the negative terminal 320B) and a negative terminal 320B. The battery case 310 may serve as a common pressure vessel for all of the electrochemical cells housed within the battery case. Hence, gases from each of the electrochemical cells are shared within the case. The battery case 310 may be hermetically sealed, however, a resealable vent, set to release gases above a maximum operating pressure, may be used to safely deal with any excessive gas generation during operation. In one embodiment, the top, bottom and side walls of the case 310 may be formed of a polymer material such as a plastic material. In one embodiment, the polymeric material for the case may be non-conductive. In another embodiment, the top, bottom and side walls of the case may be metallic.

The bipolar battery further includes an electrode stack 325 comprising a monopolar positive electrode, a monopolar negative electrode, two bipolar electrodes disposed between the positive electrode and the negative electrode. In other embodiments of the invention, there may be more that two bipolar electrodes. In general, there may be one or more bipolar electrodes. The electrode stack 325 further includes a separator disposed between adjacent electrodes. The bipolar battery 300 further includes a positive current collector 390A and a negative current collector 390B electrically coupled to opposite sides of the electrode stack 325. The positive current collector 390A may be directly coupled to the positive electrode of the electrode stack while the negative current collector 390B may be directly coupled to the negative electrode of the electrode stack. The battery 300 further includes an electrolyte. The electrolyte may, for example, be an aqueous or non-aqueous electrolyte.

For the purposes of explanation, the embodiment of the bipolar battery shown in FIG. 3 is oriented such that the length of the battery (e.g. the longer side) is in the X direction, the width of the battery (e.g. the shorter side) is in the Y direction and the height of the battery is in the Z direction. Likewise, in the embodiment of the invention shown in FIG. 3, the faces of the electrodes are aligned parallel to the X-Y plane while the height of the battery (e.g., the direction along which the electrodes are stacked) is in the Z direction. It is, of course, understood that the battery 300 may be rotated and positioned in any direction. Additional, in another embodiment of the invention, the length and width of the battery may be equal (such as in circle or a square). Generally, the shape of the bipolar battery of the present invention is not limited to any particular shape.

For the purposes of clarity, the positive and negative active compositions are not shown in FIG. 3. Likewise, it is understood that the battery includes a battery electrolyte.

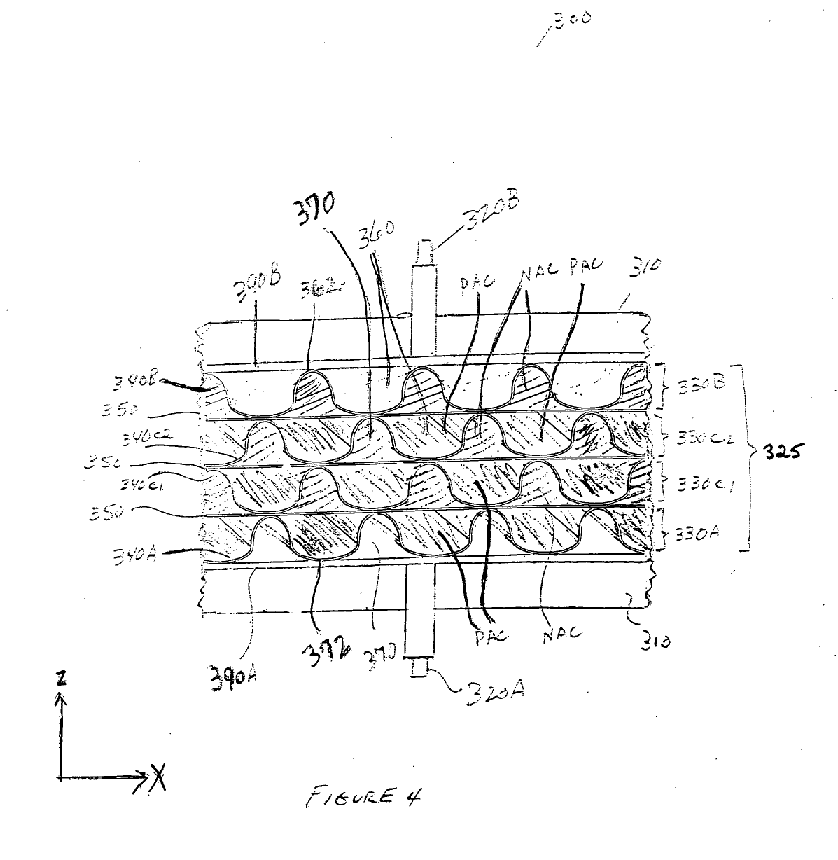

FIG. 4 shows a side view of a portion of the bipolar battery 300 through the cross-section AA shown in FIG. 3. The cross-section AA is in the Y-Z plane. FIG. 4 shows the bipolar battery 300 having a case 310, a positive terminal 320A and a negative terminal 320B. FIG. 4 shows the electrode stack 325 from FIG. 3 that includes a monopolar positive electrode 330A, a monopolar negative electrode 330B and two bipolar electrodes 330C1 and 330C2 disposed between the monopolar positive electrode and the monopolar negative electrode. The electrode stack further includes separators 350 where each separator is disposed adjacent electrodes.

The monopolar positive electrode 330A includes a positive electrode substrate 340A and a positive active composition PAC affixed to the positive electrode substrate 340A. Likewise, the monopolar negative electrode includes a negative electrode substrate 340B and a negative active composition affixed to the negative electrode substrate 340B. The bipolar electrode 330C1 includes a bipolar substrate 340C1 while the bipolar electrode 330C2 includes a bipolar substrate 340C2. A positive active composition PAC is affixed to one side of each bipolar substrate 340C1,C2 while a negative active composition NAC is affixed to the opposite side of each bipolar substrate 340C1,C2. A bipolar substrate of the present invention may also be referred to as a bipolar plate, a biplate or a bipolar substrate plate. The terms may be used interchangeably. Likewise, a corrugated bipolar substrate of the present invention may also be referred to as a corrugated bipolar plate, a corrugated biplate or a corrugated bipolar substrate plate. The terms may be used interchangeably. In an embodiment of the present invention, the bipolar plate may be non-planar.

In the embodiment shown in FIG. 4, the positive active composition PAC of one of the electrodes faces the negative active composition NAC of an adjacent electrode. A separator 350 is disposed between the positive active composition PAC of one electrode and the negative active composition NAC of an adjacent electrode. The separator 350 may, for example, be a glass mat material in which electrolyte is absorbed. The separator may be porous so as to absorb the electrolyte. The separator material may be formed of synthetic resin fibers (such as, for example, polyamide), polypropylene fibers or a combination thereof. In one embodiment, the separator may, for example, include two or more layers of non-woven polypropylene. The separator prevents the positive active composition of one electrode from physically contacting the negative active composition of an adjacent electrode. However, the separator still permits ionic communication between the positive and negative active compositions of the same electrochemical cell.

In the embodiment shown in FIG. 4, the positive electrode substrate 340A provides a structural support for the positive active composition and is electrically conducting. Likewise, in the embodiment shown in FIG. 4, the negative electrode substrate 340B provides a structural support for the negative active material and is also electrically conductive.

The bipolar substrates 340C1,C2 each provide a structural support for both the positive and negative active compositions. The bipolar substrates 340C1,C2 function to help partition the battery into individual electrochemical cells. The bipolar substrates 340C1,C2 are electrically conductive so as to create an electrical pathway between the positive active composition PAC and the negative active composition NAC of adjacent electrochemical cells. Each electrochemical cell is electrically coupled to an adjacent cell by way of the bipolar substrate. Electrical current flows from the positive active composition of one cell to negative active composition of an adjacent cell through the bipolar substrate. The current flow may be in a direction which is substantially perpendicular to a tangential plane to the surface of the bipolar substrate. (Because of the corrugations, the orientation of the surfaces of the bipolar substrates varies across the faces of the bipolar substrates in the X and Y directions). Hence, the current flow may be in the direction along the thickness dimension of the bipolar substrate. This provides a very short distance and a very large cross-sectional area through which the current passes from one electrochemical cell to an adjacent electrochemical cell.

In order to prevent shorting between adjacent electrochemical cells, in one or more embodiments of the invention, the bipolar substrates 340C1,C2 are preferably ionically non-conductive (not conductive to either positive or negative ions) so that positive or negative ions on one side of the bipolar substrate in one of the electrochemical cells cannot pass through the bipolar substrate to the other side of the bipolar substrate and into an adjacent electrochemical cell. The bipolar substrates may be adapted to prevent the ions which are part of the electrolyte (or even part of the active materials) from passing completely through the bipolar substrate from one electrochemical cell to an adjacent electrochemical cell. Each of the bipolar substrates 340C1,C2 is preferably adapted to prevent the electrolyte which is one side of the bipolar substrate in a first electrochemical cell from passing through the interior of the bipolar substrate and exiting the opposite side of the bipolar substrate in a different electrochemical cell. The bipolar substrates 340C1,C2 are preferably impermeable and/or impervious to the battery electrolyte.

In order to help ensure that the electrolyte from one electrochemical cell does not enter another electrochemical cell a hydrophopic material may be placed about the periphery of either one side or both sides of the bipolar substrate. This will create a hydrophobic border about the periphery (e.g. perimeter of the bipolar substrate. This hydrophobic border breaks the wicking path of the electrolyte and prevents the electrolyte which is on one side of the bipolar substrate from leaving that side of the substrate (where it is in one electrochemical cell) and going to the other side of the substrate (where it would be in another electrochemical cell). In one or more embodiments of the invention, the material placed about the periphery of the substrate may be a material which is capable of breaking the wicking path of the particular electrolyte used.

The bipolar battery 300 shown in FIG. 4 includes a positive current collector 390A and a negative current collector 390B. As can be seen in FIG. 4, the positive terminal 320A may be electrically connected to the positive current collector 390A while the negative terminal 320B may be electrically connected to the negative current collector 390B. The positive current collector 390A is electrically connected to the positive electrode 330A while the negative current collector 390B is electrically connected to the negative electrode 330B. In one embodiment, the positive current collector 390A may be electrically connected to the positive substrate 340A while the negative current collector 390B may be electrically connected to the negative electrode substrate 340B. In one embodiment of the invention, the positive current collector 390A may be affixed to the positive electrode substrate while the negative current collector 390B may be affixed to the negative substrate 340B. For example, the positive current collector 390A may be bonded to the positive substrate 340A while the negative current collector 390B may be bonded to the negative electrode substrate 340B. Bonding may be performed, for example, by a welding (such as a laser welding), a brazing or a soldering operation. Soldering may use a silver solder.

The positive current collector 390A and the negative current collector 390B are electrically conductive and may be formed from any conductive material. The positive current collector 390A may be formed of a material having a conductivity which is greater than the conductivity of the positive electrode substrate 340A. Likewise, the negative current collector 390B may be formed of a material having a conductivity which is greater than the conductivity of the negative electrode substrate 340B.

In the embodiment shown in FIG. 4, the positive terminal is electrically connected directly to the positive current collector 390A while the negative terminal 390B is electrically connected directly to the negative current collector 390B. (Hence, the current collectors are electrically coupled between the terminals and the electrode substrates). In a first alternate embodiment of the invention, the positive current collector may be removed so that the positive terminal is electrically connected directly to the positive electrode 330A (such as to the positive electrode substrate 340A). In a second alternate embodiment of the invention, the negative current collector may be removed so that the negative terminal is electrically connected directly to the negative electrode 330B (such as to the negative electrode substrate 340B) In a third alternate embodiment of the invention, the positive and negative current collectors may be removed so that the positive and negative terminals are electrically connected directly to the positive and negative electrodes 330A,330B, respectively (such as to the positive and negative electrode substrates 340A, 340B, respectively)

In the embodiment shown in FIG. 4, the positive electrode substrate 340A and the negative electrode substrate 340B are each electrically conducting. However, it is conceivable that in an alternate embodiment of the invention, the positive electrode substrate and the negative electrode substrate be formed of a non-conductive material so that the substrates are only used to support the positive and negative active compositions, respectively. A separate positive electrode current collector (such as a plurality of wires) may then be placed in direct contact with the positive active composition. Likewise, a separate negative electrode current collector may be placed in direct contact the negative active composition.

In the embodiment of the bipolar battery 300 shown in FIG. 4, each of the positive electrode substrates 340A, the negative electrode substrate 340B and the bipolar substrates 340C1,C2 are all corrugated. Hence, each of the substrates 340A,B,C1,C2 includes corrugations. The corrugations form channels on each side of the substrates.

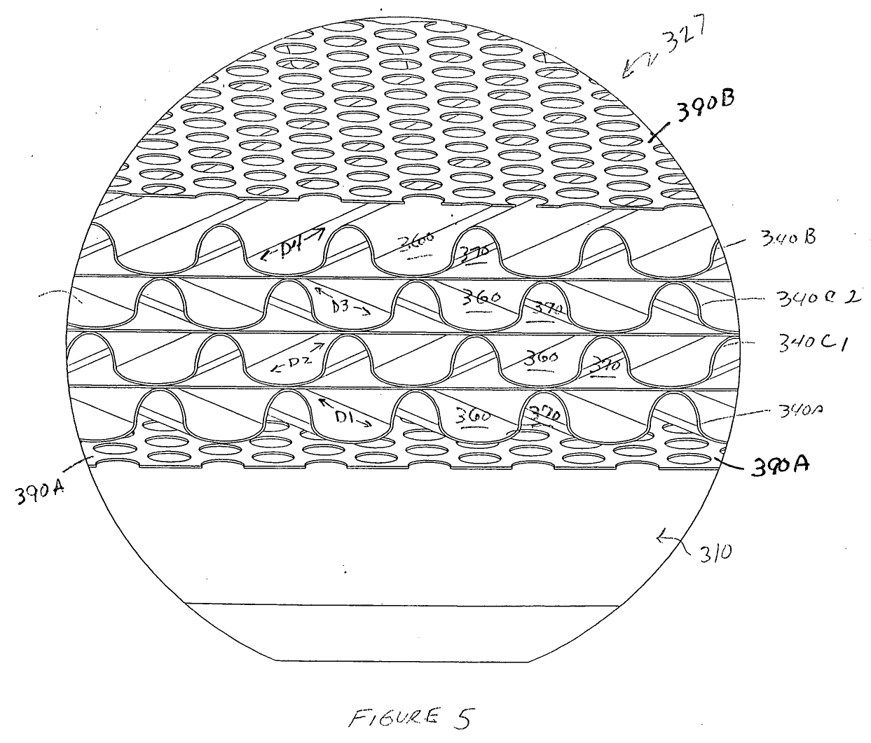

A three-dimensional view of the channels belonging to the corrugated substrates can be seen in FIG. 5. FIG. 5 is a blow up view of the circled portion 327 of battery 300 from FIG. 3. Once again, the positive active composition and negative active composition have been removed so that the channels can be seen.

Referring to FIG. 5, it is seen that the positive, negative and bipolar substrates 340A,B,C1,C2 all include positive channels 360 and negative channels 370. The positive channels of a substrate are said to be “opposite” the negative channels of the same substrate. Referring again to FIG. 4, it is seen that the positive active composition PAC is disposed in the positive channels while the negative active composition NAC is disposed in the negative channels. As noted above, the positive active composition PAC includes a positive active material PAM (such as, for example, a nickel hydroxide material) and may include additional materials. Likewise, the negative active composition NAC includes a negative active material NAM (such as, for example, a hydrogen storage alloy) and may include additional materials.

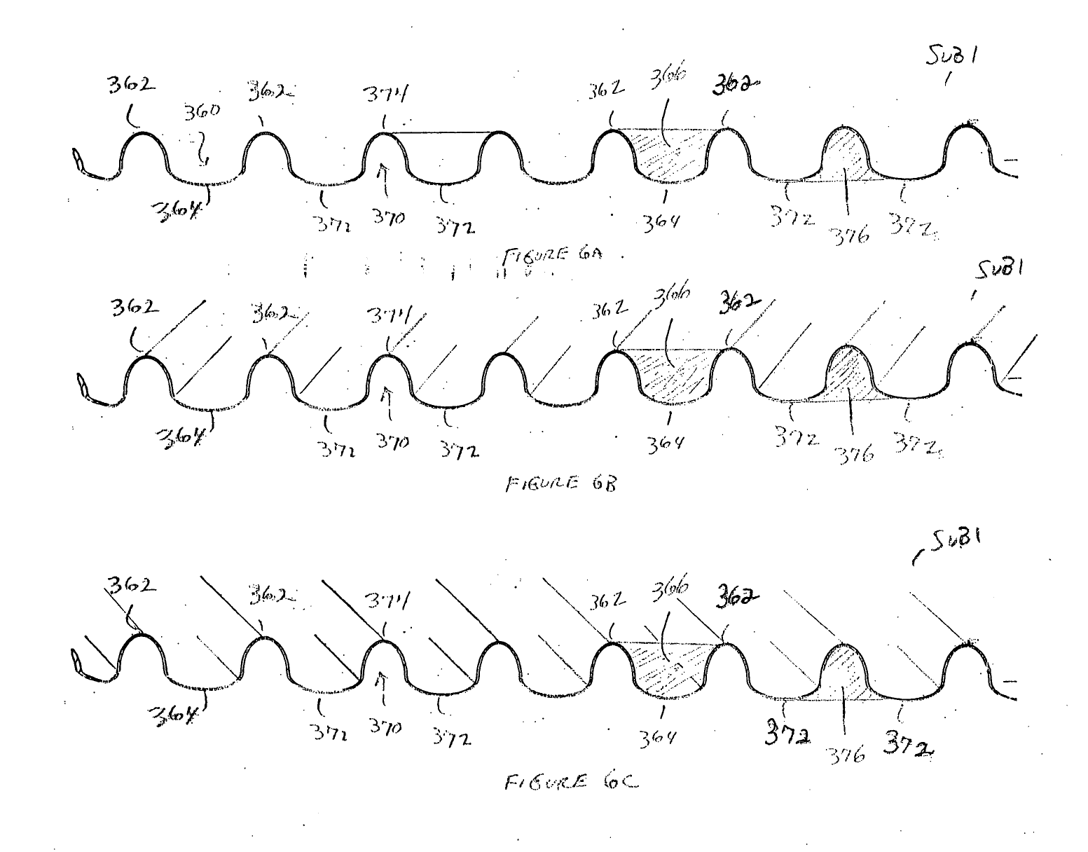

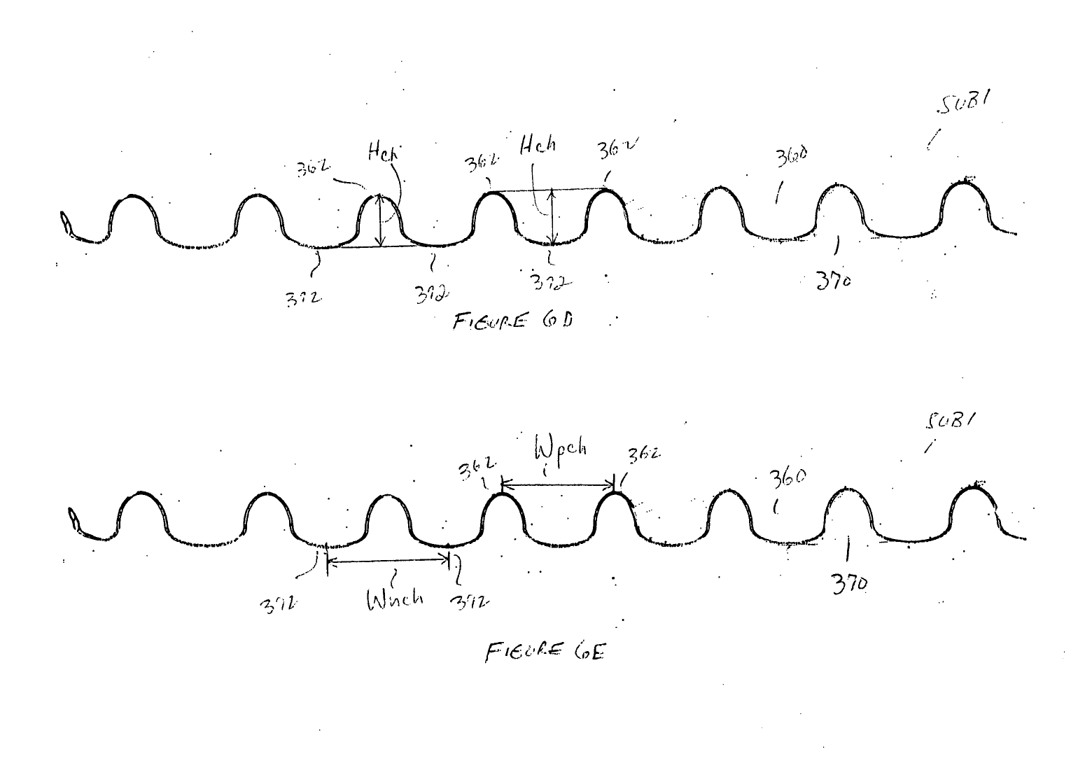

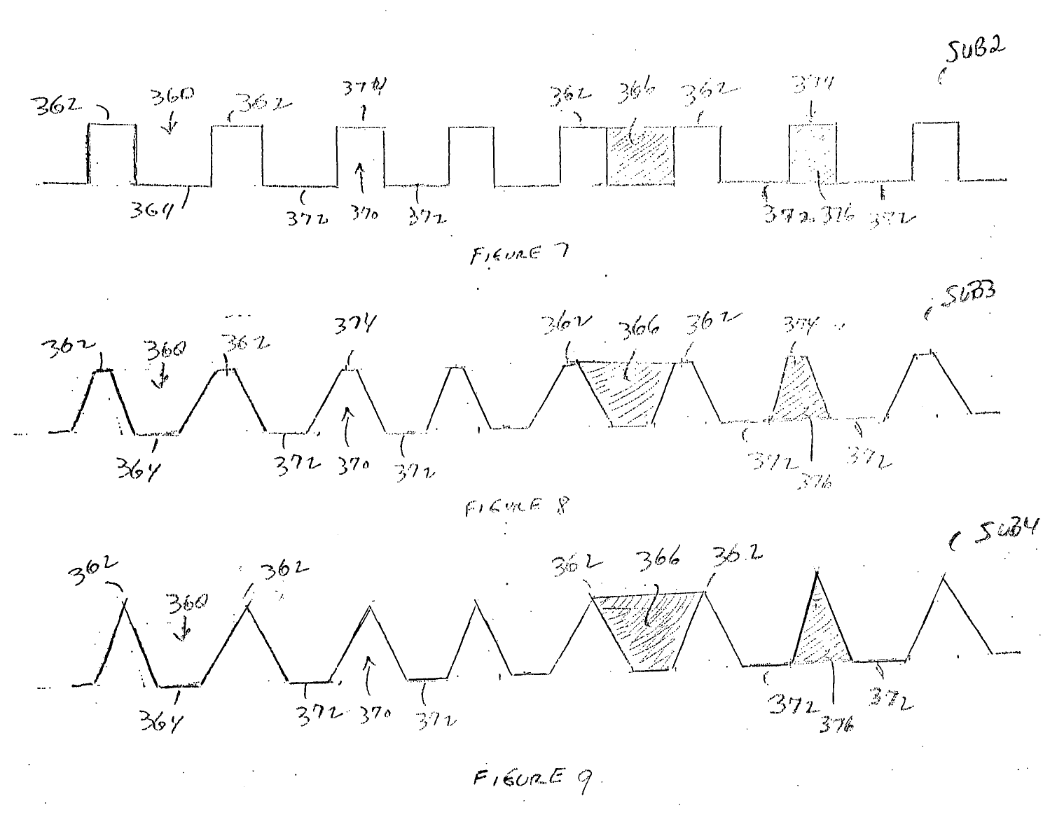

FIG. 6A shows a side view of an electrode substrate SUB1 which may be any one of the substrates 340A,B,C1,C2 from FIGS. 4 and 5. FIG. 6A shows the corrugations, the positive channels 360 and the negative channels 370 of electrode substrate SUB1. FIGS. 6B and 6C are corresponding isometric views of the electrode substrate SUB1. FIGS. 6A,B,C shows that the positive channels 360 include positive peaks 362 and positive valleys 364. Likewise, the negative channels 370 include negative peaks 372 and negative valleys 374. It is noted that the positive peaks 362 correspond to the negative valleys 374 while the negative peaks 372 correspond to the positive valleys 364.

The cross-section area of the positive channels 360 is shown as shaded area 366 which extends upward to the positive peaks 362. Likewise, the cross-section area of the negative channels 370 is shows as shaded area 376 which extends downward to the negative peaks 372. In the embodiment shown in FIGS. 6A,B,C, the area of cross-section 366 of the positive channels 360 is greater than the area of cross-section 376 of the negative channels 376. Likewise, referring to the embodiment of the invention shown in FIGS. 4 and 5, the cross-sectional area of the positive channels 360 of each of the substrates 340A,B,C1,C2 is greater than the cross-sectional area of the negative channels 370.

The height Hch of the channels of a corrugated substrate SUB1 is shown in FIG. 6D as the dimension Hch. The dimension Hch is measured in FIG. 6D as the vertical distance from the peak 362 of positive channel 360 to the peak 372 of the negative channel 370. The dimension Hch may be between about 15 mil and about 105 mil. The dimension Hch is preferably between about 20 mil and about 100 mil, more preferably between about 30 mil and about 90 mil, and most embodiment of the invention, the dimension Hch may be about 60 mil. In another embodiment of the invention, the dimension Hch may be about 70 mil.

The width Wpch of a positive channel 360 of the substrate SUB1 is shown in FIG. 6D as the dimension Wpch. The dimension Wpch is the measured from a peak 362 of a positive channel 360 to the next peak 362 of a positive channel 360. The width Wnch of a negative channel 370 of the substrate SUB1 is in FIG. 6E as the horizontal distance from one negative channel peak 372 to the next negative channel peak 372. The channel width dimensions Wpch and Wnch may be determined is relation of channel height Hch. In one embodiment, the channel width (either positive channel width Wpch and/or negative channel width Wnch) may be between 0.5 times to about 5 times that of the channel height Hch. Hence, if the channel height Hch is about 60 mils, then the channel width may be may be between about 30 mils to about 300 mils. Likewise for a height Hch of 20 mil, the channel width may be between 10 and 100 mil. For a channel height of 100 mil, the channel width may be between 50 and 500 mils. Hence, in one embodiment, the positive and/or negative channel width may range between 50 and 500 mils. In one embodiment, the positive and/or negative channel widths may be about twice that of the channel height. As an example, if the channel height is about 60 mils, then the positive and/or negative channel widths may be around 120 mil.

In an embodiment of the invention, the positive channel width Wpch may be greater than the negative channel width Wnch. In an embodiment of the invention, the positive channel width Wpch may be less than the negative channel width Wnch. In an embodiment of the invention, the positive channel width Wpch may be equal to the negative channel width Wnch.

As noted, the positive channels 360 are used to hold the positive active composition while the negative channels are used to hold the negative active composition. Referring again to FIG. 4, it is seen that for the positive electrode 330A, the positive active composition is disposed in the positive channels 360 but there is no negative active composition disposed in the negative channels 360. For the negative electrode 330B, a negative active composition is disposed in the negative channels but there is no positive active composition disposed in the positive channels. In the bipolar electrode a positive active composition is disposed in the positive channels while a negative active composition is disposed in the negative channels.

Since the cross-sectional area of the positive channels is greater than the cross-sectional area of the negative channels, if the positive active composition is made to fill the positive channels while the negative active composition is made to fill the negative channels (as, for example, shown in FIG. 4), then the total volume of positive active composition will be greater than the total volume of negative active composition.

In the embodiment shown in FIG. 4, the positive active material PAC fills the positive channels 360 and the negative active material fills the negative channels 370. However, in another embodiment of the invention, the positive active composition does not have to fill the positive channels and/or the negative active composition does not have to fill the negative channels. Likewise, in another embodiment of the invention, the positive active composition may be conformally disposed (e.g., form a substantially uniform layer) about the positive channel surface (and/or the entire positive surface of the substrate). Likewise, the negative active composition may be conformally disposed (e.g., for a substantially uniform layer) about the negative channel surface (and/or the entire negative surface of the substrate).

In another embodiment of the invention, the positive channels may be made to have a cross sectional area which is less than the cross sectional area of the negative channels. In one or more embodiments of the invention, the total volume of positive active composition may be less than the total volume of negative active composition. In yet another embodiment of the invention, the positive channels may be made to have a cross sectional area which is the same as the cross sectional area of the negative channels. In one or more embodiments of the invention, the total volume of positive active composition may be the same as the total volume of negative active composition.

Referring to FIG. 5, the directions D1, D2, D3 and D4 of the channels (and corrugations) of each of the substrates 340A, 340C1, 340C2 and 340B, respectively is shown. The direction of the channels is the direction along the length of the channels. The direction of the corrugations corresponds to the direction of the corrugations. It is seen that the substrate 340A includes channels (and corrugations) having a direction D1, the substrate 340C1 includes channels (and corrugations) having a direction D2, the substrate 340C2 includes channels (and corrugations) having a direction D3, and the substrate 340B includes channels (and corrugations) having a direction D4. In the embodiment shown, the direction D1 is different from the direction D2, the direction D2 is different from the direction D3, and the direction D3 is different from the direction D4. It is noted that the direction D1 may be the same as direction D3. Likewise, direction D2 may be the same as direction D4.

Hence, for at least a portion of the electrode stack along the X-Y direction (e.g. along the faces of the substrates) the direction of the channels (and corrugations) of one substrate is different from the direction of the overlapping channels (and corrugations) of each of the adjacent substrates. Likewise, for at least a portion of the electrode stack, the channels (and corrugations) of positive electrode substrate 340A cross the channels (and corrugations) of bipolar substrate 340C1, the channels (and corrugations) of bipolar substrate 340C1 cross the channels (and corrugations) of bipolar substrate 340C2, and the channels (and corrugations) of bipolar substrate 340C2 cross the channels (and corrugations) of negative electrode substrate 340B. Hence, for at least a portion of the electrode stack shown, the channels (and corrugations) of one the electrode substrate crosses the channels (and corrugations) of each of the adjacent electrode substrates. Hence, in the embodiment shown in FIG. 5, the corrugations of one substrate cross those of each adjacent substrate. Likewise, in the embodiment shown in FIG. 5, the channels of one substrate cross those each adjacent substrate. Allowing the channels (and corrugations) of one substrate to cross the channels (and corrugations) of an adjacent substrate provides for an electrode stack having additional strength.

Hence, in one embodiment of the present invention, each substrate has channels (and corrugations) which cross the channels (and corrugations) of each of the adjacent substrates. In another embodiment of the present invention it is only necessary that there are two adjacent substrates in a battery having channels (and corrugations) which cross each other. The two substrates may (a) be two bipolar substrates, (b) a positive electrode substrate and a bipolar substrate or (c) a negative electrode substrate and a bipolar substrate.

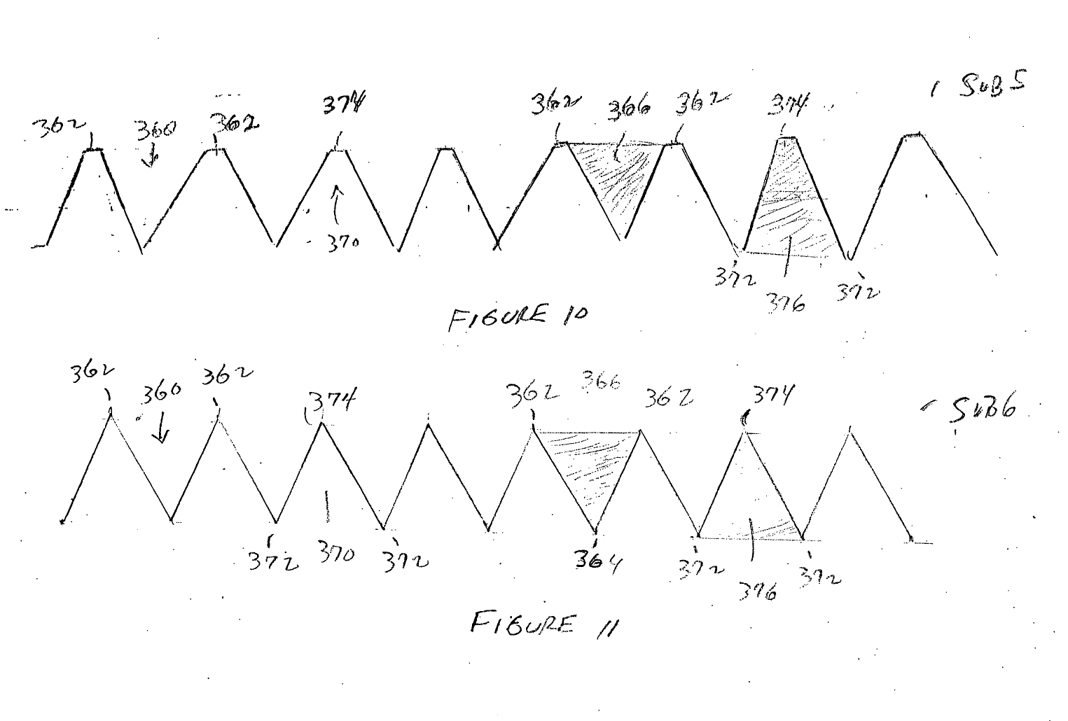

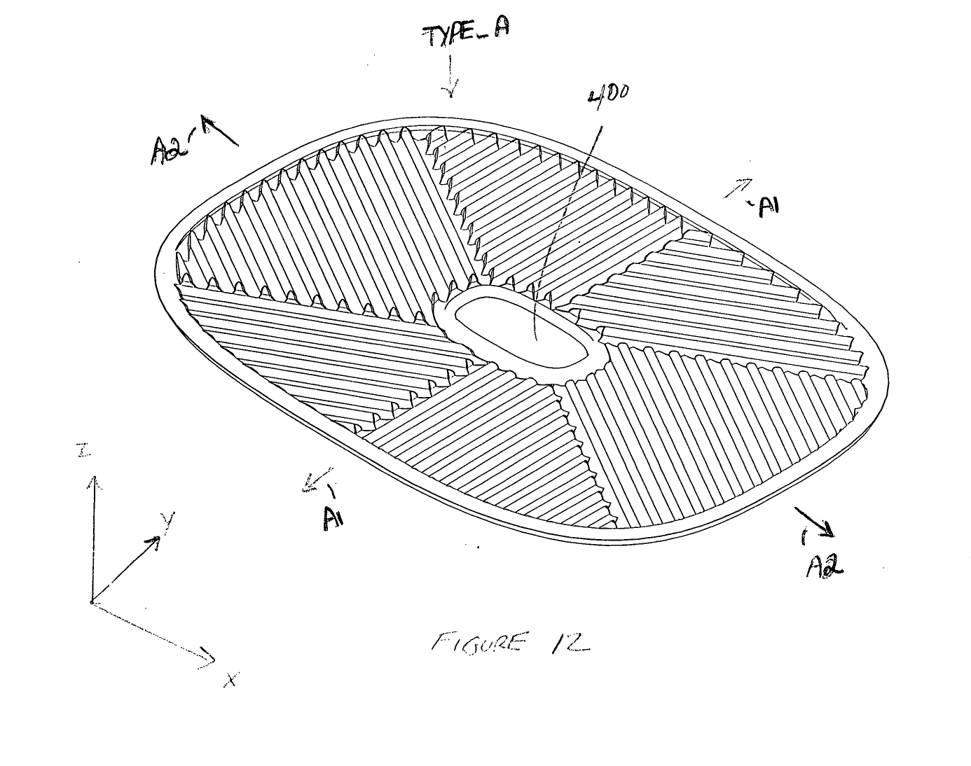

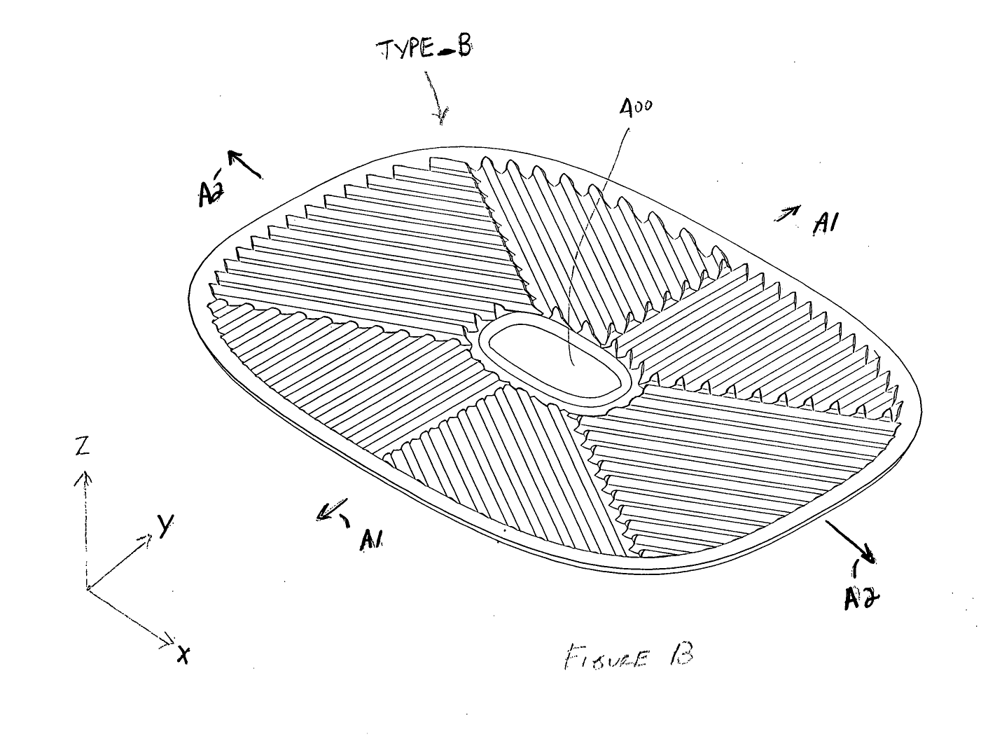

It is noted that all types of corrugations may be used for the corrugated substrates of the present invention. Hence, the cross-sectional shape of the corrugations is not limited to any particular type of shape. Additional examples of corrugation cross-sections which may be used are shown in FIGS. 7 through 11. Each of the FIGS. 7-11 shows corrugated substrates SUB2 through SUB6, respectively, with corrugations having positive openings 360 (with positive peaks 362 positive valleys 364) and with negative openings 370 (with negative peaks 372 and negative valleys 374 ). The cross-sections 366 of the positive channels 360 as well as the cross-sections 376 of the negative channels are also shown. FIG. 11 shows that the corrugations may be made up of folds. For each of the embodiments shown in FIG. 7 through 10, additional embodiments may be formed by making the cross-sectional area of the negative channels greater than the cross-sectional area of the positive channels. Likewise, additional embodiments may be formed by making the cross-sectional area of the positive channels the same as the cross-sectional area of the negative channels.

Referring to FIG. 4, the bipolar substrates 340C1,C2, the positive electrode substrate 340A, the negative electrode substrate 340B, the positive terminal 320A, the negative terminal 320B, the positive current collector 390A and the negative current collector 390B may each be formed of any conductive material. Examples of conductive materials include, without limitation, any metallic material. The metallic material may include be any pure metal and/or any metal alloy. The metallic material may be a composite material including two of more pure metals, two or more metal alloys, or at least one pure metals and at least one metal alloy. The conductive material may be any metallic material comprising one or more elemental metals from the periodic table. Examples of metallic materials include, without limitation, pure nickel, a nickel alloy, pure copper, a copper alloy, pure iron and an iron alloy. Any metallic material may be plated with any other metallic material. Examples include, without limitation, pure copper (or copper alloy) plated with pure nickel (or nickel alloy) and pure iron (or iron alloy) plated with pure nickel (or nickel alloy).

Examples of conductive materials which may be used further include conductive materials which are non-metallic. Hence, in an embodiment of the invention, the bipolar substrate may be non-metallic. Hence, in an embodiment of the invention, the bipolar plate (which is also referred to a bipolar substrate, biplate or bipolar substrate plate) may be non-metallic.

For example, the conductive material may be a conductive polymer. The conductive polymer may be a carbon-filled polymeric material (such as a carbon filled plastic). An example of a carbon-filled plastic is provided in U.S. Pat. No. 4,098,976, the disclosure of which is incorporated by reference. The plastic material may be filled with a finely divided carbon (such as a vitreous carbon, carbon black or carbon in graphite form) to form a non-corrosive, liquid-impermeable, conductive material. It is also possible to form the conductive polymer by filling a plastic material within a finely divided metal such as nickel. The materials chosen are preferably impermeable to electrolyte in order to prevent the electrolyte from one cell from entering another cell. Hence, a bipolar substrate of the present invention (which is also referred to as a bipolar plate or a bipolar substrate plate) may comprise a non-metallic conductive material.

The conductive components of the bipolar battery may be formed of the same conductive-material. Alternately, two or more of the conductive components may be formed from different conductive materials. The actual conductive material used may depend upon the actual operating conditions of the component. For example, the actual material used may depend upon the pH of the electrolyte and operating potential of the component. In an embodiment of the invention, the conductivity of the positive current collector may be greater than the conductivity of the positive electrode substrate. In an embodiment of the invention, the conductivity of the negative current collector may be greater than the conductivity of the negative electrode substrate. The battery components (e.g., positive electrode substrate, negative electrode substrate, bipolar substrates, positive and negative current collectors, positive terminal, negative terminal and case) are preferably formed from materials which are not corrosive in the battery environment. The battery environment may include on or more of the battery electrolyte used, the pH of the electrolyte and potential at which the battery component is kept during battery operation.

In one embodiment of the invention, each of the bipolar substrates may be formed of as a sheet or layer of a conductive material. In one embodiment of the invention, the bipolar substrate may be formed of a material impervious to electrolyte penetration. The bipolar substrate may be formed of a material adapted to prevent electrolyte on one side of the bipolar substrate from passing through the interior of the bipolar substrate and existing the opposite side of the substrate. In one embodiment of the invention, the bipolar substrate, may be formed of a material non-porous to the electrolyte so that there are no openings or pathways completely through the sheet from one side to the opposite side that are large enough for the electrolyte to pass through. In an embodiment of the invention, the bipolar substrate may be formed as a solid sheet of conductive material. The solid sheet may, for example, be a sheet which is everywhere dense. In an embodiment of the invention, the bipolar substrate may be a foil. The foil may be a metallic foil.

In an embodiment of the invention, the bipolar substrate may be formed as a single layer of conductive material. In another embodiment of the invention, the bipolar substrate may include two or more layers of conductive materials (for example, the layers may be stacked). In another embodiment of the invention, the bipolar substrate include two or more layers of material where one or more of layers is electrically conductive while one or more layers is not electrically conductive.

In one or more embodiments of the invention the bipolar substrate may be impervious to electrolyte. In one or more embodiments of the invention, the bipolar substrate may be formed as a single layer of material which is impervious to electrolyte. In one or more embodiments of the invention, the bipolar substrate may include two or more layers of material where each of the layers is impervious to electrolyte. In one or more embodiments of the invention, the bipolar substrate may include two or more layers of material where one or more of the layers is impervious to electrolyte while one or more of the layers is not impervious to electrolyte.

In an embodiment of the invention, the thickness of the bipolar substrate may be less than about 10 mils. In another embodiment of the invention, the thickness may be less than 8 mils. In another embodiment of the invention, the thickness may be greater than 1 mil. In one example, the thickness may be 7 mils. In another example, the thickness may be 5 mils. In another example, the thickness may be 4 mils. In another example, the thickness may be 3 mils.

In one embodiment of the invention, the positive and negative substrates have the same structure as the bipolar substrates. For example, the positive substrate, negative substrate and bipolar substrates may each be formed as a metallic foil. Alternately, the structure of the positive substrate and/or the negative substrate may be different from that of the bipolar substrates. For example, the positive and/or negative substrates may be formed as a conductive (e.g., metallic) foam, a perforated conductive (e.g., metallic) sheet, an expanded metal sheet, a conductive (e.g. metallic) screen or a conductive (e.g., metallic) mesh. In one or more embodiments of the invention, the positive and/or negative substrates may be impervious to electrolyte. In one or more embodiments of the invention, the positive and/or negative substrate may not be impervious to electrolyte.

Referring to the embodiment of FIG. 4, it is seen that the positive electrode substrate 320A, the negative electrode substrate 320B, and the bipolar substrates 330C1,C2 are all corrugated. However, in another embodiment of the invention, it is possible that the positive and/or negative substrates not be corrugated (for example, the positive and/or negative substrates may be flat). In yet another embodiment of the invention, it is also possible that one or more of the bipolar substrates (also referred to herein as a bipolar plate or a bipolar substrate plate) may not be corrugated.

Referring again to the embodiment of the bipolar battery shown in FIGS. 3 and 4, it is seen that a positive current collector 390A is electrically coupled to the positive monopolar electrode 330A and a negative current collector 390B is electrically coupled to the negative monopolar electrode 330B. In the embodiment shown in FIG. 4, the positive current collector 390A is affixed to and in electrical contact with the negative peaks 372 of the positive electrode substrate 340A. Likewise, the negative current collector 390B is affixed to and in electrical contact with the positive peaks 362 of the negative electrode substrate 340B. In the embodiment shown, the positive current collector and the negative current collector are both substantially flat sheets of a conductive material. However, in other embodiments, the positive current collector 390A may be appropriately corrugated so as to nest into the unused negative channels 370 of the positive electrode substrate 340A. Likewise, the negative current collector may be appropriately corrugated so as to nest into the unused positive channels 360 of the negative electrode substrate 340B.

In alternate embodiments of the invention, one or both of the current collectors 390A,B may be eliminated. In this case, (if the positive current collector is eliminated) the positive terminal 320A may be directly connected to the positive electrode 340A. Likewise, (if the negative current collector is eliminated) the negative terminals 320B may be directly connected to the negative electrode 340B. The positive terminal may be directly connected to the positive substrate 330A. Likewise, the negative terminal may be directly connected to the negative substrate 330B.

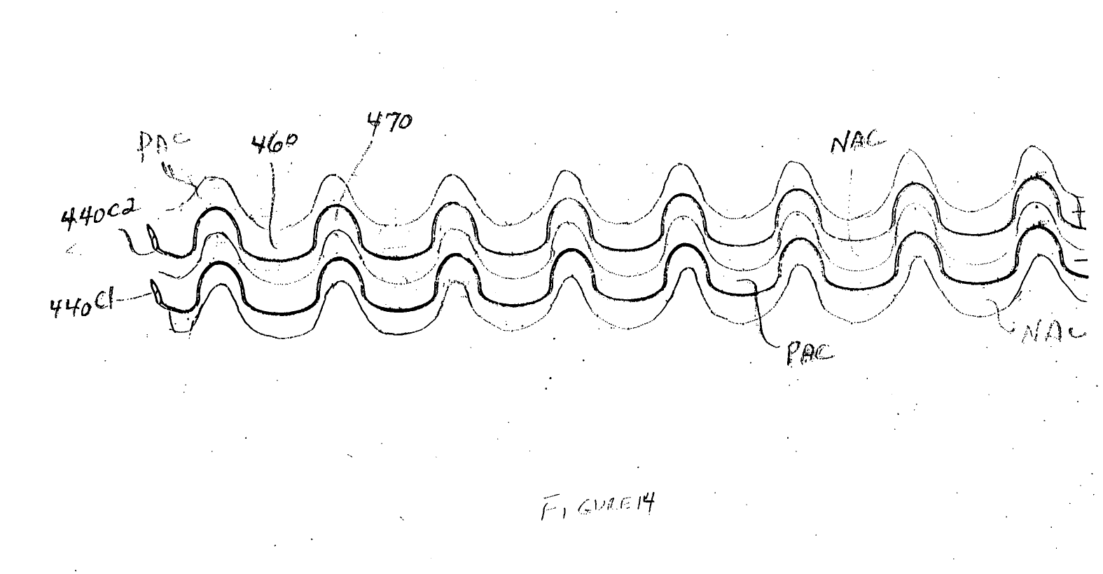

An example of a corrugated bipolar substrate (also referred to as a corrugated bipolar plate, a corrugated biplate or a corrugated bipolar substrate plate) of the present invention is substrate TYPE_A shown in FIG. 12. Another example of a corrugated bipolar substrate (also referred to as a corrugated bipolar plate, a corrugated biplate or a corrugated bipolar substrate plate) of the present invention is shown as substrate TYPE_B shown in FIG. 13.

In one embodiment of the invention, the corrugated substrates TYPE_A and TYPE_B may be corrugated foils (such as metallic foils). Of course, as discussed above, other materials may be used. The substrates TYPE_A, TYPE_B may be used as positive and negative monopolar substrates as well as for bipolar substrates.

The substrates TYPE_A and TYPE_B, as shown in FIGS. 12 and 13 are each in the form of a third order ellipse, however, other shapes are possible. For example, the bipolar substrates may be formed as a second order ellipse, a circle, a rectangle, a square, a polygon, etc. The bipolar substrate of the present is not limited to any particular shape.

In the embodiments shown in FIGS. 12 and 13, there are six grouping of corrugations with each group having an orientation different from its two adjacent groups. Other corrugation patterns are possible and the bipolar substrate of the present invention is not limited to any particular corrugation pattern. For example, the corrugations may be concentric (for example, concentric loops about the faces of the substrate.

Referring to FIG. 12, the substrate TYPE_A has a first center axis A1 (e.g. a short axis) in the Y direction and a second center axis A2 (e.g. a long axis) in the X direction. Likewise, referring to FIG. 13, the substrate TYPE_B has a first axis A1 (e.g. a short axis) in the Y direction and a second axis A2 (e.g. a long axis) in the X direction. In the embodiments shown in FIGS. 12 and 13, the positive side of substrate TYPE_B is the mirror image of the positive side of TYPE_A. Likewise, the negative side of substrate TYPE_A is the mirror image of the negative side of substrate TYPE_B. The mirror plane may include the A1 axis. Alternately, the mirror plane may include the A2 axis.

The substrates TYPE_A and TYPE_B from FIG. 12 and 13 are used as the bipolar and monopolar substrates of the bipolar battery shown in FIGS. 3, 4 and 5. Using alternating substrates for the electrodes of the bipolar battery permits the stacking of the electrodes such that corrugations and corresponding channels of the substrates of adjacent electrodes cross each other as shown, for example, in FIG. 5.

As an example, referring to FIG. 5, the positive electrode substrate 340A may be a substrate TYPE_B, the bipolar substrate 340C1 may be a substrate TYPE_A, the bipolar electrode substrate 340C2 may be a TYPE_B substrate, and the bipolar electrode substrate 340B may be a TYPE_A substrate. In an alternate embodiment of the invention, the positive electrode substrate 340A may be a substrate TYPE_A, the bipolar substrate 340C1 may be a substrate TYPE_B, the bipolar substrate 340C2 may be a substrate TYPE_A, and the negative electrode substrate 340B may be a substrate TYPE_B.

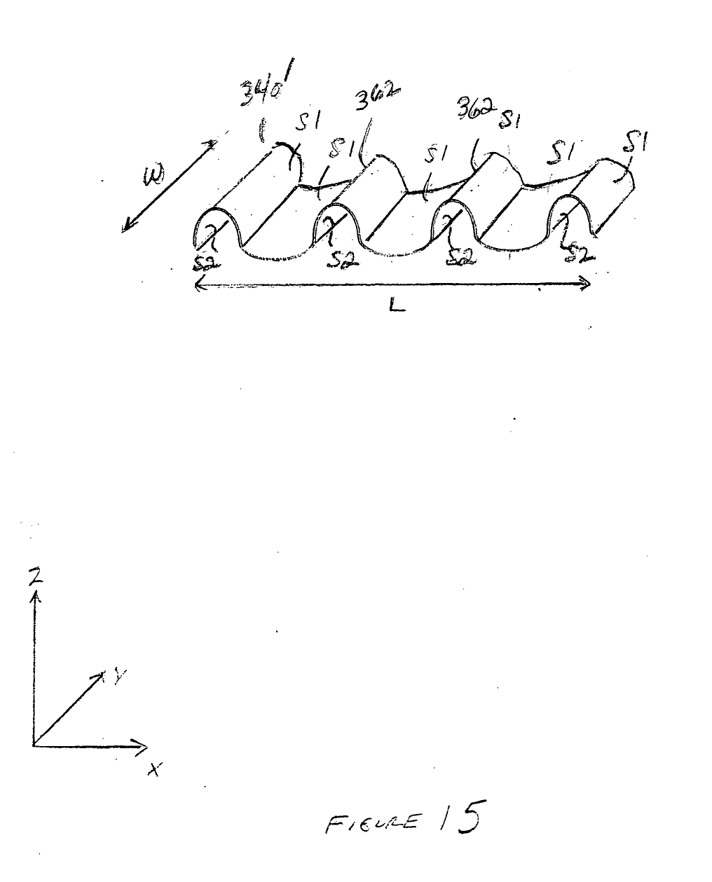

In an alternate embodiment of the invention, the channels (and corrugations) of all of the electrode substrates may be oriented in the same direction. Likewise, the positive channels (and corrugations) of one are aligned with the positive channels (and corrugations) of each adjacent substrate and the negative channels (and corrugations) of one are aligned with the negative channels (and corrugations) of each adjacent substrate. This example is shown in FIG. 14 which shows how the positive channels 460 of bipolar substrate 440C2 fit or nest within the positive channels 460 of bipolar substrate 440C1. Likewise, the negative channels 470 of bipolar substrate 440C1 fit within the negative channels 470 of bipolar substrate 440C1. The configuration shown in FIG. 14 is referred to as a nested configuration. For a nested configuration, the channels of one substrate nest within the channels of an adjacent substrate. Likewise, the corrugations of one substrate nest within the corrugations of an adjacent substrate.

The positive active composition PAC and the negative action composition NAC are also shown in FIG. 14. In the example shown in FIG. 14 the positive active composition is disposed on one side (for example, the top side) of each substrate while the negative active composition may be disposed on the opposite side (for example, the bottom side) of each substrate. A separator (not shown in FIG. 14) would be placed between the two electrodes such that the positive active composition of one does not touch the negative active composition of the other. Of course, a positive electrode may be nested with a bipolar electrode. Likewise, a negative electrode may be nested with a bipolar electrode.

It is noted that in an alternate embodiment of the invention, it is possible to have two or more electrodes that cross and two or more electrodes that are nested. Certain substrates may have corrugations (and channels) that cross those of an adjacent substrate while other substrates may have corrugations (and channels) that nest with those of an adjacent substrate.

The configuration shown in FIG. 14 may be achieved by using the substrate TYPE_A for each of the bipolar substrates 440C1,C2. Likewise, the configuration may be achieved by using the substrate TYPE_B of FIG. 13 for each of the substrates 440A,B.

Referring again to the embodiments of the bipolar substrates shown in FIGS. 12 and 13, it is seen the substrate TYPE_A and substrate TYPE_B are each in the shape of a third order ellipse. It is noted that the bipolar substrate of the present invention is not limited to any particular shape. Additional examples of shapes include, without limitation, circular, square, rectangular, polygonal, other forms of ellipse, etc. In the examples shown in FIGS. 12 and 13, the bipolar substrates TYPE_A and TYPE_B are shaped so that the material of the substrate forms a loop-shape. The loop-shape defines an opening 400 which is surrounded by the substrate material. (Hence, it is noted that the substrate material may be a solid-sheet of material, however, the shape of the solid-sheet of material defines an opening (or even more that one opening) which is then surrounded by the substrate material. In the embodiments shown in FIGS. 12 and 13, the opening 400 may be used for collection of battery gases. When multiple bipolar substrates are stacked, the openings 400 also stack to form a central region within the bipolar battery. This central region may be used to collect gases from each of the electrochemical cells. A valved port may be placed in gasous communication with the central region. A tensioning rod may be placed through this central region for the purpose of applying pressure (e.g., a uniform pressure) on the top and bottom of the electrode stack.

Referring to the substrates TYPE_A and TYPE_B shown in FIGS. 12 and 13, in an embodiment of the invention, an inner collection channel may be placed about the perimeter of the opening 400 (e.g. about the inner perimeter of the substrate) to collect excess electrode active composition that may expand during battery operation. Likewise, in an embodiment of the invention, an outer collection channel may be placed about the outer perimeter of the substrate, on the opposite side of the substrate, to collect excess active electrode material from the opposite type of material. In another embodiment of the invention, inner channels may be placed on both sides of the substrate. In another embodiment of the invention, outer channels may be placed on both sides of the substrate.

FIG. 15 shows a portion 340′ of a corrugated bipolar substrate of the present invention. In the embodiment shown all of the positive peaks. 362 and all of the negative peaks 372 are in the same plane parallel to the X-Y plane. The substrate 340′ has a length L in the X direction and a width W in the Y direction. The substrate footprint is the two dimensional footprint of the substrate 340′ in the X-Y plane. This substrate footprint has the dimension L×W (length times width). It is noted that the area of the bipolar substrate footprint is distinguishable from the actual surface area of either top surface S1 or the bottom surface S2 of the corrugated substrate 340′. In the embodiment shown the total surface area of the top surface S1 is greater than the surface area of the footprint. Likewise, the total surface area of the bottom surface S2 is greater than the surface area of the substrate footprint. It is noted that the footprint of the bipolar electrode is also the projection to the X-Y plane. Likewise, the footprint of any object (such as the bipolar battery) is its projection to the X-Y plane.

The bipolar battery of the present invention formed using a corrugated bipolar substrate of the present invention may have many advantages over a bipolar battery that uses flat bipolar plates (such as the bipolar battery shown in FIG. 2). For example, the corrugated bipolar substrate may more efficiently support the active positive and negative compositions that a flat bipolar plate. A flat bipolar plate may require additional support means to support the active compositions (e.g. additional meshes or screens). Hence, the corrugated bipolar substrate may provide for greater electrical conductivity between the positive and negative active electrode compositions so as to reduce the resistance of the bipolar electrodes and the bipolar battery. Likewise, the corrugated bipolar substrate may reduce costs since extra parts are not needed.

In one or more embodiments of the invention, for a particular footprint dimension (e.g. L×W), a corrugated bipolar substrate may hold more positive and negative active material than a flat bipolar plate having the same footprint. In one or more embodiments of the invention, the capacity of a bipolar battery using corrugated bipolar substrates (and having a particular sized footprint) may be greater than the capacity of a bipolar battery using flat bipolar plates (and having the same footprint). Likewise, in one or more embodiments of the invention, for a bipolar battery with a particular capacity, the footprint of the bipolar electrode using a corrugated bipolar substrate may be less than the footprint of a bipolar electrode using a flat bipolar plate.

In one or more embodiments of the invention, for a given capacity bipolar battery, the footprint of the battery may be less with the use of corrugated bipolar substrates. Hence, the surface area of the top and bottom of the battery case may be reduced so that there may be less total pressure on the top and bottom surfaces (where the total pressure may be due to battery gases as well as to expansion and contraction of the electrodes). Hence, it may be easier to restrain the top and bottom surfaces of the battery case with less hardware (e.g. restraining mechanisms) thereby lowering the cost of the battery.

Alternately, in one or more embodiments of the invention, the volume of a bipolar electrode using a corrugated bipolar substrate (having a particular capacity) may be less that the volume of a bipolar electrode using a flat bipolar plate (having the same capacity).

It is noted that in an embodiment of the invention, the bipolar substrates of the present invention may have any shape which is non-planer. One or both of the surfaces may be three-dimensional. In one embodiment of the invention, the bipolar substrate may have ridges and valleys. In one embodiment the substrate may have protrusions and depressions. The ridges and valleys form channels or pockets on both sides of the substrate. In one embodiment of the invention, the bipolar substrate has lands and grooves. In one embodiment of the invention, the bipolar substrate has first channels on one side and second channels on the opposite side. In one embodiment of the invention, the bipolar substrate has first pockets on one side and second pockets

The positive active composition PAC of the present invention comprises a positive active material PAM. Generally, the positive active material may be any active electrode material known in the art useful for a battery. Examples of positive active materials include, but are not limited to, lead dioxide, lithium cobalt dioxide, lithium nickel dioxide, lithium manganese oxide compounds, lithium vanadium oxide compounds, lithium iron oxide, lithium compounds (as well as complex oxides of these compounds), transition metal oxides, manganese dioxide, zinc oxide, nickel oxide, nickel hydroxide, manganese hydroxide, copper oxide, molybdenum oxide and carbon fluoride. Combinations of these materials may also be used. A preferred positive active material for the bipolar battery is a nickel hydroxide material. It is within the scope of this invention that any nickel hydroxide material may be used. Examples of nickel hydroxide materials are provided above.

The negative active composition NAC includes a negative active material NAM. The negative active material may include any negative active material known in the art useful for a battery. Examples of negative active materials for the bipolar battery of the present invention include, but not limited to, metallic lithium and like alkali metals, alkali metal absorbing carbon materials, zinc, zinc oxide, cadmium, cadmium oxide, cadmium hydroxide, iron, iron oxide, and hydrogen storage alloys. A preferred active negative electrode material for the negative electrode of the bipolar battery of the present invention is a hydrogen storage alloy. It is within the spirit and scope of this invention that any hydrogen storage alloy may be used as negative active material for the bipolar battery of the present invention. Generally, any hydrogen storage alloy may be used. Hydrogen storage alloys include, without limitation, AB, AB₂ and AB₅ type alloys. For example, hydrogen storage alloys may be selected from rare-earth/Misch metal alloys, zirconium alloys or titanium alloys. In addition mixtures of alloys may be used. An example of a particular hydrogen storage material is a hydrogen storage alloy having the composition (Mm)ₐNi_{b}Co_{c}Mn_{d}Alₑ where Mm is a Misch Metal comprising 60 to 67 atomic percent La, 25 to 30 weight percent Ce, 0 to 5 weight percent Pr, 0 to 10 weight percent Nd; b is 45 to 55 weight percent; c is 8 to 12 weight percent; d is 0 to 5.0 weight percent; e is 0 to 2.0 weight percent; and a+b+c+d+e=100 weight percent. Other examples of hydrogen storage alloys are described above.

The bipolar battery of the present invention is not limited to any particular battery chemistry. The battery may use any electrolyte. For example, the bipolar battery may be a non-aqueous battery (using a non-aqueous electrolyte) or an aqueous battery (using an aqueous electrolyte). An example of a nonaqueous electrochemical battery is a lithium-ion battery. The lithium-ion battery may use a liquid organic or a polymer electrolyte. In addition, the lithium-ion cell uses intercalation compounds for both the positive active material and the negative active material.

Aqueous batteries may be acidic batteries which use an acidic electrolyte. An example of an acidic battery is a lead-acid battery. For the case of the lead acid battery, the electrolyte may be a sulfuric acid. The positive active material is lead dioxide while the negative active material is metallic lead.

Aqueous batteries may be alkaline batteries which use an alkaline electrolyte. Many of the alkaline batteries are nickel based. Examples of such batteries are nickel metal hydride batteries (NiMH), nickel cadmium batteries (NiCd), nickel hydrogen batteries (NiH), nickel zinc batteries (NiZn), and nickel iron cells (NiFe). Alkaline electrochemical cells include an alkaline electrolyte. An alkaline electrolyte is preferably an aqueous solution of an alkali metal hydroxide. Examples of alkali metal hydroxides include potassium hydroxide, lithium hydroxide, sodium hydroxide and mixtures thereof.

Hence, an embodiment of a bipolar battery of the present invention is a nickel metal hydride bipolar battery comprising a positive monopolar electrode, a negative monopolar electrode, at least one bipolar electrode and an alkaline electrolyte. As noted, the alkaline electrolyte is preferably an aqueous solution of an alkali metal hydroxide. Examples of alkali metal hydroxides include potassium hydroxide, sodium hydroxide, lithium hydroxide, and mixtures thereof. Preferably, the alkali metal hydroxide is potassium hydroxide. The positive active material is a nickel hydroxide material and the negative active material is a hydrogen storage alloy (also referred to as a metal hydride material).

Another embodiment of the present invention is a nickel cadmium bipolar battery. In this embodiment the electrolyte is also an alkaline electrode. The positive active material is a nickel hydroxide material and the negative active material is cadmium.

The positive active composition and/or the negative active composition may include additives. The additives may be conductive additives. Conductive additives may include carbon (such as a graphite or graphite containing composite). Conductive additives may be formed of a metallic material such as a pure metal or a metal alloy. The metallic material may include one or more of the elements Ni, Cu, Zn, Co, and Ag. The conductive additives may include a conductive polymer. The additives may include cobalt oxide, zinc oxide, silver oxide. The additives may include transition metals, rare earth metals or misch metals. The additives may be in the form of particles. The particles may have any shape and may be in the form of fibers. The additives may be physically mixed together with the active electrode material. The additives may be at least partially embedded within the particles of active material. See, for example, U.S. Pat. No. 6,177,213, the disclosure of which is hereby incorporated by reference herein. The additives may at least partially encapsulate of the particles of active material.

As noted, an additive may a conductive polymer. The conductive polymer may be an intrinsically electrically conductive materials. Generally, any conductive polymer may be used in the active composition. Examples of conductive polymers include conductive polymer compositions based on polyaniline such as the electrically conductive compositions disclosed in U.S. Pat. No. 5,783,111, the disclosure of which is hereby incorporated by reference herein. Polyaniline is a family of polymers. Polyanilines and their derivatives can be prepared by the chemical or electrochemical oxidative polymerization of aniline (C₆ H₅ NH₂). Polyanilines have excellent chemical stability and relatively high levels of electrical conductivity in their derivative salts. The polyaniline polymers can be modified through variations of either the number of protons, the number of electrons, or both.

The polyaniline polymer can occur in several general forms including the so-called reduced form (leucoemeraldine base) possessing the general formula 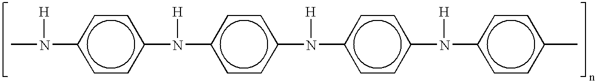
the partially oxidized so-called emeraldine base form, of the general formula 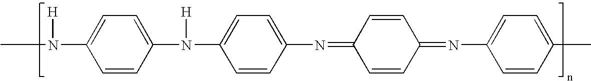
and the fully oxidized so-called pernigraniline form, of the general formula

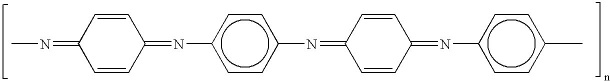

In practice polyaniline generally exists as a mixture of the several forms with a general formula (I) of

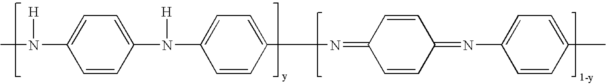

When 0≦y≦1, the polyaniline polymers are referred to as poly(paraphenyleneamineimines) in which the oxidation state of the polymer continuously increases with decreasing value of y. The fully reduced poly(paraphenylenamine) is referred to as leucoemeraldine, having the repeating units indicated above corresponds to a value of y=0. The fully oxidizedpoly(paraphenyleneimine) is referred to as pernigraniline, of repeat unit shown above corresponds to a value y=0. The partly oxidized poly(paraphenyleneimine) with y in the range of greater than or equal to 0.35 and less than or equal to 0.65 is termed emeraldine, though the name emeraldine is often focused on y equal to or approximately 0.5 composition. Thus, the terms “leucoemeraldine”, “emeraldine” and “pernigraniline” refer to different oxidation states of polyaniline. Each oxidation state can exist in the form of its base or in its protonated form (salt) by treatment of the base with an acid.

The use of the terms “protonated” and “partially protonated” herein includes, but is not limited to, the addition of hydrogen ions to the polymer by, for example, a protonic acid, such as an inorganic or organic acid. The use of the terms “protonated” and “partially protonated” herein also includes pseudoprotonation, wherein there is introduced into the polymer a cation such as, but not, limited to, a metal ion, M+. For example, “50%” protonation of emeraldine leads formally to a composition of the formula:

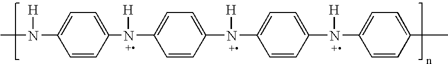

Formally, the degree of protonation may vary from a ratio of [H+]/[−N=]=0 to a ratio of [H+]/[−N=]=1. Protonation or partial protonation at the amine (—NH—) sites may also occur.

The electrical and optical properties of the polyaniline polymers vary with the different oxidation states and the different forms. For example, the leucoemeraldine base forms of the polymer are electrically insulating while the emeraldine salt (protonated) form of the polymer is conductive. Protonation of the emeraldine base by aqueous HCl (1M HCl) to produce the corresponding salt brings about an increase in electrical conductivity of approximately 10¹⁰. The emeraldine salt form can also be achieved by electrochemical oxidation of the leucoemeraldine base polymer or electrochemical reduction of the pernigraniline base polymer in the presence of the electrolyte of the appropriate pH level.

Some of the typical organic acids used in doping emeraldine base to form conducting emeraldine salt are methane sulfonic acid (MSA) CH3—S03 H, toluene sulfonic acid (TSA), dodecyl bezene sulphonic acid (DBSA), and camphor sulfonic acid (CSA).

Other examples of conductive polymers include conductive polymer compositions based on polypyrrole. Yet other conductive polymer compositions are conductive polymer compositions based on polyparaphenylene, polyacetylene, polythiophene, polyethylene dioxythiophene, polyparaphenylenevinylene.

In one embodiment of the invention, the conductive polymer may, for example, be between about 0.1 weight percent and about 10 weight percent of the active composition. In another embodiment, the conductive polymer may be less than 1 weight percent of the active composition.

The positive and/or negative active compositions may include include a Raney catalyst; a Raney alloy or some mixture thereof. A Raney process refers to a process for making a porous, active metal catalyst by first forming at least a binary alloy of metals, where at least one of the metals can be extracted, and then extracting that metal whereby a porous residue is obtained of the insoluble metal which has activity as a catalyst. See for example, “Catalysts from Alloys-Nickel Catalysts” by M. Raney, Industrial and Engineering Chemistry, vol. 32, pg. 1199, September 1940. See also U.S. Pat. Nos. 1,628,190, 1,915,473, 2,139,602, 2,461,396, and 2,977,327. The disclosures of U.S. Pat. Nos. 1,628,190, 1,915,473, 2,139,602, 2,461,396, and 2,977,327 are all incorporated by reference herein. A Raney process metal refers to any of a certain group of the insoluble metals well known in the Raney process art which remain as the porous residue. Examples of insoluble Raney process metals include, not limited to, nickel, cobalt, silver, copper and iron. Insoluble alloys of nickel, cobalt, silver, copper and iron may also be used.

A Raney alloy comprises an insoluble Raney process metal (or alloy) and a soluble metal (or alloy) such as aluminum, zinc, or manganese, etc. (Silicon may also be used as an extractable material). An example of a Raney alloy is a Raney nickel-aluminum alloy comprising the elements nickel and aluminum. Preferably, the Raney nickel-aluminum alloy comprises from about 25 to about 60 weight percent nickel and the remainder being essentially aluminum. More preferably, the Raney nickel-aluminum alloy comprises about 50 weight percent nickel and about 50 weight percent aluminum.

A Raney catalyst is a catalyst made by a Raney process which includes the step of leaching out the soluble metal from the Raney alloy. The leaching step may be carried out by subjecting the Raney alloy to an aqueous solution of an alkali metal hydroxide such as sodium hydroxide, potassium hydroxide, lithium hydroxide, or mixtures thereof. After the leaching step, the remaining insoluble component of the Raney alloy forms the Raney catalyst.

An example of a Raney catalyst is Raney nickel. Raney nickel may be formed by subjecting the Raney nickel-aluminum alloy discussed above to the Raney process whereby most of the soluble aluminum is leached out of the alloy. The remaining Raney nickel may comprise over 95 weight percent of nickel. For example, a Raney alloy in the form of a 50:50 alloy of aluminum and nickel (preferably in the form of a powder) may be placed in contact with an alkaline solution. The aluminum dissolves in the solution thereby leaving behind a finely divided Raney nickel particulate. (The particulate may then be filtered off and added to the active electrode composition of the present invention). Other examples of Raney catalysts are Raney cobalt, Raney silver, Raney copper, and Raney iron.

A Raney catalyst and/or a Raney alloy may be added to an electrode (either a monopolar electrode or a bipolar electrode) of the bipolar battery. The Raney catalyst and/or Raney alloy may be added to the electrodes in many different ways. For example, a Raney catalyst and/or Raney alloy may be added to the positive active composition or the negative active composition.

The Raney catalyst and/or Raney alloy may be mixed with the active material to form a mixture. For example, a Raney catalyst and/or Raney alloy may be mixed with an active electrode material (either a negative active material NAM or a positive active material PAM and a conductive polymer to form an active composition in the form of a mixture. The mixture may then be formed into an electrode. For example, an electrode may be formed by applying the mixture to a conductive substrate.

The Raney catalyst and/or Raney alloy may be applied to one or more surfaces of either the monopolar or bipolar electrode. For example, a electrode may be formed by first applying an active electrode material to a conductive substrate and then applying a Raney catalyst and/or Raney alloy to an outer surface of the active electrode material). The Raney catalyst and/or Raney alloy may exist as a discrete outer layer of the electrode. The thickness of this Raney catalyst and/or Raney alloy layer may be as thin as 30 Angstroms or less. Alternately, it may be as high as 2 microns or more. The actual thickness used depends, as least partially, upon the catalytic activity of Raney catalyst used. Alternately, the Raney catalyst and/or Raney alloy that is applied to an outer surface of an electrode may pass below the surface and enter the bulk of the electrode. Hence, the Raney catalyst and/or Raney alloy may form a graded structure having a higher concentration at the surface of the electrode and a lower concentration inside the bulk of the electrode. Also, the Raney catalyst and/or Raney alloy may be layered or continually graded within the bulk of the electrode.

The Raney catalyst and/or Raney alloy may also be deposited onto the surface of each of the active electrode material particles. This may provide for increases catalytic activity throughout the entire bulk of the electrode material. The Raney catalyst and/or Raney alloy may or may not completely coat each of the active material particles. The Raney catalyst and/or Raney alloy coatings may have a thickness from about 20 Angstroms to about 150 Angstroms.

As noted above, a Raney alloy may be added to the positive and/or negative active composition of the bipolar battery instead of (or in addition to) a Raney catalyst. It may thus be possible to form the Raney catalyst “in situ” by adding a Raney alloy to the negative composition or the positive composition. For example, a Raney alloy (such as a nickel-aluminum alloy) may be mixed in with a hydrogen storage alloy to form a negative active composition NAC for the bipolar battery. The alkaline electrolyte of the battery may be used to leach out the aluminum so that a Raney nickel catalyst is thus formed. Further discussion of the Raney alloys and Raney catalysts is provided in U.S. Pat. No. 6,218,047, the disclosure of which is hereby incorporated by reference herein.

The positive and/or negative active composition of the present invention may include a binder material which can further increase the particle-to-particle bonding of the active electrode material as well as the particle-to-substrate bonding between the active electrode material and an electrode substrate that may be used to support the active composition. The binder materials may, for example, be any material which binds the active material together so as to prevent degradation of the electrode during its lifetime. Binder materials should preferably be resistant to the conditions present within the electrochemical cells. Examples of additional binder materials, which may be added to the active composition, include, but are not limited to, polymeric binders such as polyvinyl alcohol (PVA), carboxymethyl cellulose (CMC) and hydroxypropylymethyl cellulose (HPMC). Other examples of polymeric binders include fluoropolymers. An example of a fluoropolymer is polytetrafluoroethylene (PTFE). Other examples of additional binder materials, which may be added to the active composition, include elastomeric polymers such as styrene-butadiene. In addition, depending upon the application, additional hydrophobic materials may be added to the active composition (hence, the additional binder material may be hydrophobic).

The positive active composition PAC for the electrodes may be used as the positive active composition for either the monopolar positive electrode or the bipolar electrodes of the bipolar battery of the present invention. Likewise, the negative active composition NAC for the electrodes may be used as the negative active composition for either the monopolar negative electrode or for the bipolar electrodes of the bipolar battery of the present invention. The monopolar and/or bipolar electrodes may be formed in any way. The electrodes may be formed by affixing the active electrode composition onto a conductive substrate. The active composition may be affixed to the substrate in many ways.

The positive and/or negative active compositions may be formed as a mixture. The mixture may be formed by physically mixing the active electrode material (and optionally with any other desired additives such as conductive materials, Raney catalysts, Raney alloys or additional binders). Mixing may be accomplished by a ball mill (with or without the mixing balls), a blending mill, a sieve, or the like. The mixture may be in the form of a dry mixture or in the form of a wet mixture. The monopolar and/or bipolar electrodes may be non-paste type electrodes whereby the active composition is in the form of a dry powder. The dry powder is applied to a conductive substrate and then compressed onto the substrate. The electrode may be sintered after it is compressed.

A wet mixture may formed as a paste by adding water and a “thickener” such as carboxymethyl cellulose (CMC) or hydroxypropylmethyl cellulose (HPMC) to the active composition. The monopolar and bipolar electrodes may be a paste-type electrode. For example, the monopolar and bipolar electrode may be formed by first making the active composition into a paste and then applying the paste to a conductive substrate. The paste may be formed by adding water and a “thickener” such as carboxymethyl cellulose (CMC) or hydroxypropylmethyl cellulose (HPMC). The paste would then be applied to a conductive substrate. The electrode may then be compressed and may be sintered after it is compressed.

### EXAMPLE

An example of a bipolar battery of the present invention is a nickel-metal hydride bipolar battery. The bipolar battery is formed using a positive electrode, a negative electrode and fourteen (14) bipolar electrodes that form a total of 15 electrochemical cells. Each of the electrodes are formed for corrugated substrates. The positive channels have a cross sectional surface area which is greater than that of the negative channels. Each of the substrates is in the form of a pure nickel foil. The thickness of the foil is approximately 5 mils. The battery uses both positive and negative current collectors formed from pure copper. The bipolar battery uses either the substrate TYPE_A shown in FIG. 13 or the substrate TYPE_B shown in FIG. 14. The substrate TYPE_A and the substrate TYPE_B are alternatingly stacked. Hence, the substrate TYPE_A is used as the positive electrode substrate, TYPE_B as the first bipolar substrate, TYPE_A as the second bipolar substrate and so on. (Of course, in another example, the stack may begin with a substrate TYPE_B).

A positive active composition paste is formed using nickel hydroxide as the positive active material. The positive active composition is formed as a paste by physically mixing the nickel hydroxide material with cobalt powder, cobalt oxide powder and a PVA binder.

A negative active composition paste is formed using a hydrogen storage alloy as the negative active material. The negative active composition is formed as a paste by physically mixing the hydrogen storage alloy with a TEFLON binder, carboxymethyl cellulose CMC, polyacrylic salt (PAS) and carbon.

The positive active electrode composition and the negative active composition are both pastes that are applied to the positive and negative channels of the TYPE_A and TYPE_B substrates. The first bipolar electrode may be stacked above the positive electrode, the second bipolar electrode may be stacked above the first bipolar electrode and the negative electrode may be stacked above the second bipolar electrode. Separators are placed between adjacent electrodes.

While the invention has been described in connection with preferred embodiments and procedures, it is to be understood that it is not intended to limit the invention to the preferred embodiments and procedures. On the contrary, it is intended to cover all alternatives, modifications and equivalence, which may be included within the spirit and scope of the invention as defined by the claims appended hereinafter.

1. A bipolar battery, comprising:
a bipolar electrode comprising a bipolar substrate, said bipolar substrate having a first surface supporting a positive active composition and a second surface supporting a negative active composition, said first surface and said second surface being non-planar.

2. A bipolar battery, comprising:
a bipolar electrode, comprising:
a bipolar substrate having corrugations, said corrugations forming first channels and second channels opposite said first channels;
a first active composition disposed in said first channels; and
a second active composition disposed in said second channels, said first and second active compositions being of opposite types.

3. The bipolar battery of claim 2, wherein the cross-sectional area of said first channels is greater than the cross-sectional area of said second channels.

4. The bipolar battery of claim 3, wherein said first active composition is a positive active composition and said second active composition is a negative active composition.

5. The battery of claim 2, wherein said first active composition is conformally disposed along the surface of said first channels and said second active composition is conformally disposed along the surface of said second channels.

6. The battery of claim 2, wherein said first active composition fills said first channels and said second active composition fills said second channels.

7. The battery of claim 2, wherein said first active composition comprises a nickel hydroxide material.

8. The battery of claim 2, wherein said second active composition comprises a hydrogen storage alloy.

9. The battery of claim 2, wherein said bipolar substrate comprises a metallic material.

10. The battery of claim 2, wherein said bipolar substrate comprises a metallic foil.

11. The battery of claim 2, wherein said bipolar substrate hag a thickness of less than 10 mils.

12. The battery of claim 2, wherein said bipolar substrate comprises a non-metallic conductive material.

13. A bipolar battery, comprising:
a first electrode including a first substrate with first corrugations, said first corrugation forming first channels and second channels opposite said first channels; and
a second electrode adjacent said first electrode, said second electrode including a second substrate with second corrugations, said second corrugations having first channels and second channels.

14. The bipolar battery of claim 13, wherein said first corrugations cross said second corrugations.

15. The bipolar battery of claim 13, wherein said first corrugations are nested in said second corrugations.

16. The bipolar battery of claim 13, wherein the first channels of said first substrate have a cross sectional area which is greater than the second channels of said first substrate, the first channels of said second substrate have a cross sectional area which is greater than the second channels of said second substrate.

17. The bipolar battery of claim 13, wherein said first electrode is a bipolar electrode, said first substrate is a bipolar substrate and said second electrode is a monopolar electrode.

18. The bipolar battery of claim 13, wherein said first electrode is a bipolar electrode, said first substrate is a bipolar substrate, said second electrode is a bipolar electrode and said second substrate is a bipolar substrate.

19. The bipolar battery of claim 13, wherein said battery is a nickel metal hydride battery.

20. The bipolar battery of claim 13, wherein said battery is a lithium ion battery.

21. The bipolar battery of claim 13, wherein said first substrate has a first side and a second side, said second substrate has a first side and a second aide, the first side of said first substrate being a mirror image of said first side of said second substrate, the second side of said first substrate being a mirror image of said second side of said second substrate.

22. The bipolar battery of claim 2, wherein said first active composition is a positive active composition and said second active composition is a negative active composition.

23. A first bipolar battery, comprising:
one or more first bipolar electrodes, each of said first bipolar electrodes including a first bipolar substrate supporting a positive active composition and a negative active composition; and
an electrolyte,
said first bipolar battery having a footprint smaller than the footprint of a second bipolar battery using a planar bipolar plate, the capacity and chemistry of said second battery being the same as the capacity and chemistry of said first battery.

24. The first battery of claim 23, wherein said chemistry is a nickel-metal hydride chemistry.

25. The first battery of claim 23, wherein said first bipolar substrate of each of said bipolar electrodes has corrugations.
